(19) United States
(12) Patent Application Publication
(10) Pub. No.: US 2019/0109559 A1
(43) Pub. Date: Apr. 11, 2019

(54) WATER TIGHT PHOTOVOLTAIC ROOFING SYSTEM

(71) Applicant: DOW GLOBAL TECHNOLOGIES LLC, Midland, MI (US)

(72) Inventors: Joseph A. Langmaid, Caro, MI (US); Leonardo C. Lopez, Midland, MI (US); Gerald K. Eurich, Merrill, MI (US); Stephen G. Pisklak, Hockessin, DE (US)

(21) Appl. No.: 16/097,122

(22) PCT Filed: Jul. 5, 2016
(86) PCT No.: PCT/US2016/040936

§ 371 Date: Oct. 26, 2018

Related U.S. Application Data
(60) Provisional application No. 62/194,443, filed on Jul. 20, 2015.

(51) Int. Cl. H02S 20/23; F24S 25/40

(52) U.S. Cl. CPC H02S 20/23; F24S 2020/13; F24S 25/40

(57) ABSTRACT

A plurality of photovoltaic components (3) comprising: (a) one or more rows of overlapping active components (20) comprising a plurality of connection members (10) and (b) one or more flashing components (60) comprising a plurality of connection members (10); wherein the plurality of connection members (10) of the one or more rows of overlapping active components (20) and the plurality of connection members (10) of the flashing components (60) form a mating relationship in a mating region so that the one or more rows of overlapping active components and the one or more flashing components are connected together such that fluid is prevented from passing between the one or more rows of overlapping active components and the one or more flashing components in the mating region, and wherein the connection members are located inward of a peripheral edge and/or prevent wind uplift.

### FIELD

The present teachings generally relate to an improved photovoltaic roofing system that connects directly to a building structure and provides a water tight barrier that protects the building structure.

### BACKGROUND

Typically, photovoltaic arrays are placed in an elevated location such as a roof top of a home or a building or in a rack and frame that elevates the photovoltaic array so that the photovoltaic array is exposed to sunlight. The roofs on homes and/or buildings generally are formed by adding a plurality of pieces of panels together so that a generally contiguous surface is formed, which are supported by one or more trusses. Photovoltaic modules may be secured to the plurality of pieces of panels directly and/or indirectly via a connection structure such as a rack and frame. Each photovoltaic module of the photovoltaic array may include only an active portion and the active portions of two or more photovoltaic modules may be placed in close proximity with one another so that a photovoltaic array is formed over and/or on the connection structure. However, in cases where the photovoltaic modules provide roofing functions, the photovoltaic modules may include both an active portion and a support portion and the active portion of one photovoltaic module may fully and/or partially cover the support portion of an adjacent photovoltaic module to replace the framing and racking structure. Further, the active portion and the support portion are one integrally formed piece with the photovoltaic active portion located within the active portion so that in order to remove the photovoltaic active portion the entire photovoltaic module would be removed and replaced if necessary. In cases of building integrated photovoltaics, the support portion may provide roofing functions or structural functions for subsequent photovoltaic modules. However, the photovoltaic array does not cover the entire roofing structure, thus, standard roofing shingles are needed to create the remaining protective barrier for the roofing structure. The interface between the roofing shingles and photovoltaic array components and between photovoltaic array components provide areas where water may penetrate the photovoltaic structure.

Examples of some photovoltaic modules and photovoltaic arrays may be found in U.S. Pat. Nos. 5,437,735; 7,985,919; 8,631,614; and 8,898,970 U.S. Patent Application Publication No. 2008/0271773; 2008/0302030; 2010/0146878; 2010/0180523; 2012/0118349; and 2014/0165480; and International Patent Application Nos. WO2011/019886 and WO2013/019628 all of which are incorporated by reference herein for all purposes.

It would be attractive to have a system that interfaces the photovoltaic array and standard roofing shingles so that a water tight seal is created between the photovoltaic array and standard roofing shingles. It would be attractive to have flashing pieces that form an integral connection with the photovoltaic modules such that a water tight barrier is created without reducing the area available for collecting sunlight. What is needed is a system that resists windup lift while preventing fluid penetration into the photovoltaic array. What is needed is a series of self-interlocking photovoltaic array components that lock together and form a fluid tight structure without the need for additional sealing material.

### SUMMARY

The present teachings meet one or more of the present needs by providing: a plurality of photovoltaic components comprising: (a) one or more rows of overlapping active components comprising a plurality of connection members and (b) one or more flashing components comprising a plurality of connection members; wherein the plurality of connection members of the one or more rows of overlapping active components and the plurality of connection members of the flashing components form a mating relationship in a mating region so that the one or more rows of overlapping active components and the one or more flashing components are connected together such that fluid is prevented from passing between the one or more rows of overlapping active components and the one or more flashing components in the mating region, and wherein the connection members are located inward of a peripheral edge and/or prevent wind uplift.

The present teachings provide: a method of forming a photovoltaic array comprising: (a) forming a starter row by placing a plurality of photovoltaic components on a support structure; (b) attaching the starter row to the support structure; (c) placing one or more internal rows at least partially overlapping the starter row; (d) connecting the one or more internal rows to the starter rows; and (e) placing an ending row at least partially overlapping the internal rows so that a water resistant connection is formed between the ending rows and the starter rows.

The present teachings provide: a plurality of photovoltaic components comprising: (a) one or more overlapping rows of active components comprising a plurality of connection members and (b) one or more flashing components comprising a plurality of connection members; wherein the one or more overlapping rows of active components at least partially overlap the one or more flashing components or vice versa and the plurality of connection members of the active component and the plurality of connection members of the flashing component form a mating relationship in a mating region that is located inward of a peripheral edge so that the one or more active components and the one or more flashing components are connected together such that fluid is prevented from passing between the one more active components and the one or more flashing components in the mating region.

The teachings herein surprisingly solve one or more of these problems by providing a system that interfaces the photovoltaic array and standard roofing shingles so that a water tight seal is created between the photovoltaic array and standard roofing shingles. The present teachings provide flashing pieces that form an integral connection with the photovoltaic modules such that a water tight barrier is created without reducing the area available for collecting sunlight. The present teachings provide a system that resists wind uplift while preventing fluid penetration into the photovoltaic array. The present teachings provide a series of self-interlocking photovoltaic array components that lock together and form a fluid tight structure without the need for additional sealing material.

### BRIEF DESCRIPTION OF THE DRAWINGS

FIG. 1 illustrates a top perspective view of a photovoltaic array;

FIG. 2 illustrates partial cross-sectional view of the photovoltaic array of FIG. 1;

FIG. 3 illustrates a bottom view of connection members mated together;

FIG. 4 illustrates a cross-sectional view of two overlapped photovoltaic modules and the connection members mated together;

FIG. 5 illustrates an exploded view of the photovoltaic array of FIG. 1;

FIG. 6 illustrates a top perspective view of a top right plus piece;

FIG. 7 illustrates a bottom perspective view of the top right plus piece of FIG. 6;

FIG. 7A illustrates a close-up view of a bottom of FIG. 7;

FIG. 8 illustrates a top perspective view of a top right minus piece;

FIG. 9 illustrates a bottom perspective view of the top right minus piece of FIG. 8;

FIG. 9A illustrates a close-up view of the bottom of FIG. 9;

FIG. 10 illustrates a top perspective view of a bottom left minus piece;

FIG. 11 illustrates a bottom perspective view of the bottom left minus piece of FIG. 10;

FIG. 12 illustrates a top perspective view of a bottom piece;

FIG. 12A illustrates a close-up view of the flashing interface of FIG. 12;

FIG. 13 illustrates a bottom perspective view of the bottom piece of FIG. 12;

FIG. 14 illustrates a top perspective view of a bottom right plus piece;

FIG. 15 illustrates a bottom perspective view of the bottom right plus piece of FIG. 14;

FIG. 16 illustrates a top perspective view of a bottom right minus piece;

FIG. 17 illustrates a bottom perspective view of the bottom right minus piece of FIG. 16;

FIG. 18 illustrates a top perspective view of a bottom left plus piece;

FIG. 19 illustrates a bottom perspective view of the bottom left plus piece of FIG. 18;

FIG. 20 illustrates a top perspective view of a left piece;

FIG. 20A illustrates a close-up view of the row to row connector portion of FIG. 20;

FIG. 21 illustrates a bottom perspective view of the left piece of FIG. 20;

FIG. 22 illustrates a top perspective view of a door;

FIG. 23 illustrates a bottom perspective view of the door of FIG. 22;

FIG. 24 illustrates a top perspective view of a top piece;

FIG. 25 illustrates a bottom perspective view of the top piece of FIG. 24;

FIG. 26 illustrates a top perspective view of a top left minus piece;

FIG. 27 illustrates a bottom perspective view of the top left minus piece of FIG. 26;

FIG. 28 illustrates a top perspective view of a top left plus piece;

FIG. 29 illustrates a bottom perspective view of the top left plus piece of FIG. 28;

FIG. 30 illustrates a top perspective view of a step in right piece;

FIG. 31 illustrates a bottom perspective view of the step in right piece of FIG. 30;

FIG. 32 illustrates a top perspective view of a step in left piece;

FIG. 33 illustrates a bottom perspective view of the step in left piece of FIG. 32;

FIG. 34 illustrates a top perspective of a module;

FIG. 35 illustrates a bottom perspective view of the module of FIG. 34;

FIG. 36 illustrates a top perspective view of a right piece;

FIG. 37 illustrates a bottom perspective view of the right piece of FIG. 36;

FIG. 38 illustrates a close-up view of a top of a door inserted into the flashing component of FIG. 6;

FIG. 39 illustrates a bottom close-up view of a bottom of a door inserted into the flashing component of FIG. 6; and

FIG. 40 illustrates a close-up view of snap slots of FIG. 37.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled.

A plurality of photovoltaic components (e.g., active components and flashing components) of the teachings herein are combined together to form a photovoltaic array. The photovoltaic array collects sunlight and converts the sunlight to electricity. Generally, each of the active components (e.g., photovoltaic modules) may be individually placed in a structure that houses all of the photovoltaic modules forming all or a portion of a photovoltaic array. The photovoltaic components of the teachings herein may be used with a housing that contains all of the individual photovoltaic components and make up a photovoltaic array. Preferably, the photovoltaic array taught herein is free of a separate structure that houses all of the photovoltaic components that make up a photovoltaic array (also referred to as a solar array). More preferably, each individual photovoltaic component may be connected directly to a structure (i.e., is a building integrated photovoltaic (BIPV)) and each of the individual photovoltaic components is electrically connected together so that a photovoltaic array is formed. The photovoltaic components may be connected to a support structure that forms a connection surface.

The connection surface may function to provide support to one or more photovoltaic components so that a photovoltaic array is formed. Preferably, the connection surface may be a roof. The roof may be made of any material that has sufficient strength to support the weight of the plurality of photovoltaic modules. The roof may be made of any material so that the plurality of photovoltaic modules may be directly connected to the roof. The plurality of photovoltaic components may be connected to the connection surface so that the photovoltaic components are adjacent to one another. Preferably, the photovoltaic components may partially overlap each other. For example, the active portion and/or a support portion of one photovoltaic module may overlap an overlap portion of one or more adjacent photovoltaic modules in a similar fashion to how roofing shingles are applied to a roof. Preferably, a support portion of a base plate of one photovoltaic module may extend at least partially over an overlap portion of an adjacent base plate.

The photovoltaic components may be aligned in rows (e.g., horizontally) or columns (e.g., vertically), but as discussed herein both rows and columns will be referred to as rows. The photovoltaic array may include two or more rows, three or more rows, four or more rows, or even five or more rows. Preferably, the photovoltaic array may include a plurality of rows. The combination of rows of photovoltaic components when connected together form a photovoltaic array that includes a peripheral edge. The peripheral edge is the outer edge that extends around an outer most region of the photovoltaic array. The photovoltaic components may be staggered from row to row. For example, an upper photovoltaic component may overlap a portion of two or more lower photovoltaic components. Preferably each photovoltaic component is staggered and overlaps two photovoltaic components and each of the overlapped photovoltaic components has a portion that extends outside of the overlapping photovoltaic component. Each of the photovoltaic components either overlaps one or more adjacent photovoltaic components, is overlapped by one or more adjacent photovoltaic components, or both overlaps and is overlapped by one or more adjacent photovoltaic components. The overlap may form a double overlap so that each of the photovoltaic components is covered forming a shingle effect. The active components and the flashing components may connect together in an overlapped fashion forming the photovoltaic array as set forth herein.

Each of the photovoltaic components function to form a portion of the photovoltaic array that prevents the ingress of water. Each of the photovoltaic components serves a roofing function. The photovoltaic components may each include a surface that removes water from the roofing structure, prevents water from penetrating into the photovoltaic array. Each photovoltaic component may be connectable to one or more adjacent photovoltaic components so that a water tight seal is formed. Each of the photovoltaic components include a peripheral edge. The peripheral edge is an edge that extends about a perimeter of each photovoltaic component. The peripheral edge may include one or more top edges, one or more side edges, one or more bottom edges, or a combination thereof. The peripheral edge may be free of any connection members. The peripheral edge may overhang any connection members of the photovoltaic components. For example, a connection member may be located a distance away from the peripheral edge. The connection member may be located about 1 cm or more, about 2 cm or more, or about 3 cm or more from the closest peripheral edge, any peripheral edge, every peripheral edge, or a combination thereof. The connection member may be located about 50 cm or less, about 40 cm or less, even about 35 cm or less, about 20 cm or less, or about 12 cm or less from a closest peripheral edge, any peripheral edge, every peripheral edge, or a combination thereof. For example, the connection member may be located 5 cm or more from a bottom edge, 10 cm or more from a top edge, 5 cm or more from a first side edge, and 25 cm or more from a second side edge. The peripheral edge may overhang the connection members to that connection members are not visible from the top. The peripheral edge may overhang the connection members so that during installation the installation is a “blind” installation. The connection member's may be located in a central region of the photovoltaic components.

The connection members may function to connect two or more photovoltaic components together. The connection members may function to mate together and prevent fluid from passing through the photovoltaic array. Two or more connection members may connect together in a mating region. The mating region may be a region where the photovoltaic components overlap and connect together. The mating region may be a region where the connection members form a complementary fit together. The mating region be a region where two or more connection members align to connect two or more photovoltaic components together. The two or more connection members may extend in the direction of the slope of the support structure (e.g., vertically), perpendicular to the direction of the support structure (e.g., horizontally, or a direction between horizontal and vertical. The connection members may prevent wind uplift. The connection members may prevent lateral movement, longitudinal movement, vertical movement, of a combination thereof of two or more connected photovoltaic components. The connection members may be a male and female component. The connections members may form a mating relationship. The connections members may be a connection hook, a connection recess, or both. Each photovoltaic component includes at least one connection member. Each photovoltaic component may include a plurality of connection members. Some photovoltaic components may include only a connection hook or only a connection recess. Some photovoltaic components include both connection hooks and connection recesses. For example, a photovoltaic component may include a plurality of connection recesses in an overlap portion and a plurality of connection hooks in an active portion or a cap portion.

The one or more connection recesses may function to connect two or more adjacent photovoltaic components, two or more adjacent base plates, two or more photovoltaic modules, two or more flashing components, two or more active components, a flashing component and an active component, or a combination thereof together. The one or more connection recesses may prevent movement of two or more active components, two or more photovoltaic modules, two or more flashing components, or a combination thereof relative to each other. The one or more connection recesses may function to receive a portion of an adjacent photovoltaic component. The one or more connection recesses may extend along a width of the photovoltaic component. The one or more connection recesses may extend transverse to the slope of the roof. The one or more connection recesses may be located in the overlap portion, the support portion, the cap portion, or a combination thereof. The one or more connection recesses may be spaced apart along the photovoltaic component so that the connection recesses may receive a portion of two or more adjacent photovoltaic components (e.g., a connection hook). The one or more connection recesses may be located along edges but inside of the edge, in edge regions, in a central region, or a combination thereof of the photovoltaic components. Preferably the connection recesses are evenly spaced out across the base plate, the photovoltaic module, or both. The photovoltaic components may include zero, two or more, three or more, four or more, or even five or more connection recesses, connection hooks, or both. The one or more connection recesses may be a plurality of connection recesses that each receives a portion of an adjacent photovoltaic component. The one or more connection recesses may be a through hole that extends through the photovoltaic component (e.g., flashing component or base plate). The connection recesses may be a recess in the photovoltaic component that does not extend through the photovoltaic component. The one or more connection recesses may be any shape that may receive a portion of an adjacent photovoltaic component so that the photovoltaic components are locked relative to each other, movement relative to each other is prevented, or both. The one or more connection recesses may be round, square, rectangular, oval, octagonal, triangular, a rhombus, or a combination thereof. The one or more connection recesses may include one or more walls that create a border around the connection recesses.

The one or more walls may function to support an adjacent photovoltaic module above the connection recess. The one or more walls may function to prevent fluid from entering into the connection recess. The one or more walls may be an elevated surface that extends from the base plate proximate to the connection recesses. The walls may extend sufficiently high so that the walls contact a bottom side of an adjacent photovoltaic component and the bottom side acts as a lid. The walls may be a plurality of walls that extend around a connection recess. The walls may be a single wall that extends about a periphery of the connection recess. The walls may be interconnected. A single wall may extend around two or more, three or more, or even four or more connection recesses. A space may be located between the walls. The walls may be one unitary structure that extends from the photovoltaic component. The walls may assist in creating a fixed connection with an adjacent photovoltaic module. The walls may assist in placing two adjacent photovoltaic components in tension. For example, when a connection hook extends through the connection recess and contacts a rib or a wall on the bottom side of the photovoltaic component the upper photovoltaic component may be pulled so that the upper photovoltaic component contacts the wall so that the connection hook and the rib or wall are always in contact. The one or more connection recesses may receive one or more connection hooks in a mating region and the walls of the connection recesses may contact an underside of the overlapping photovoltaic component in the mating region forming a water tight connection.

The one or more connection hooks may function to prevent movement (e.g., vertical, horizontal, longitudinal, diagonal, or a combination thereof) of two or more photovoltaic components, two or more photovoltaic modules, two or more active components, two or more flashing components, at least one flashing component and at least one active component, or a combination thereof relative to each other. The one or more connection hooks may prevent wind uplift. The one or more connection hooks may extend into a connection recess. The one or more connection hooks may be complementary to the one or more connection recesses. The photovoltaic components may include an equal number of connection hooks and connection recesses. The one or more connection hooks may extend through a connection recess. The one or more connection hooks may contact a portion of the connection recess, an area adjacent to the connection recess, a rear side of the photovoltaic components, the photovoltaic module, a rib, or a combination thereof. The one or more connection hooks may extend through the connection recess and then turn and contact a portion of the photovoltaic components, an opposing side, an internal wall, or a combination thereof. The one or more connection hooks may extend into the connection recess and contact a portion of the inside of the connection recess. The one or more connection hooks may be smaller than the connection recess. A gap may be located on one or both sides, one or both edges, or both of the connection hooks. The one or more gaps may allow the connection hook to move side to side, forward and backwards, diagonally, or a combination thereof. The one or more gaps may allow the connection hooks to extend into the connection recess without being completely aligned. For example, if two adjacent photovoltaic components are not completely aligned the connection recess may have enough space so that the connection hook can still extend into the connection recess. The gaps may be sufficiently large so that the connection hooks can move side to side in the connection recess during formation of a connection. The one or more gaps may be about 1 mm or more, 2 mm or more, 3 mm or more, or even about 5 mm or more. The one or more gaps may be about 5 cm or less, preferably about 4 cm or less, more preferably about 3 cm or less, or even more preferably about 2 cm or less. The one or more connection hooks may extend into the connection recess and into contact with a rib or wall that puts tension of the connection hook so that the photovoltaic component is prevented from lifting. The one or more connection hooks may be located along edges but inside of the edge, in edge regions, in a central region, or a combination thereof of the base plate. Preferably the connection hooks are substantially evenly spaced out across the photovoltaic components. The photovoltaic components may include two or more, three or more, four or more, or even five or more connection hooks.

The one or more connection hooks may have a portion that extends in the direction of the slope of the connection structure (i.e., vertically), opposite the slope of the connection structure, perpendicular to the direction of the slope (i.e., horizontally) of the connection structure, or a combination thereof. The one or more connection hooks may extend from a rear side the photovoltaic components. The one or more connection hooks may include one or more lock features. The one or more lock features may form a fixed connection with a connection recess, a rib, a wall, or a combination thereof. The one or more lock features may function to provide an indication that a lock is formed. The one or more lock features may function to provide resistance when detaching the connection hook from the connection recess. The one or more lock features may be a detent, a snap feature, an interlock, a lip, or a combination thereof. The one or more connection hooks may be on an opposite side of the base plate as the handles, on an opposite end of the overlap portion as the handles, or both. The one or more connection members may be located proximate to one or more fastener supports.

The fastener supports may be located within the active portion, the overlap portion, the support portion, cap portion, in the photovoltaic components, or a combination thereof. Preferably, the fastener supports may be located within the overlap portion. The fastener supports may be a through hole that extends through the overlap portion, a weakened area so that a fastener may be placed through the fastener support, a removable portion, a punch out, an area of lower hardness, or a combination thereof. Preferably, the fastener supports may be a region where the photovoltaic components are reinforced so that fasteners may extend through and connect the photovoltaic component to the one or more connection surfaces and the fasteners do not damage the photovoltaic laminate when the photovoltaic component, the overlap portion, or both is subjected to movement. The one or more fastener supports and preferably a plurality of fastener supports may be located in the support portion, the overlap portion, or both of the base plate, the flashing components, the active components, or a combination thereof. The one or more fastener supports may accept one or more fasteners.

The plurality of photovoltaic components may be connected to the connection surface by any fastener that has sufficient strength to withstand environmental conditions and form a secure connection. The plurality of photovoltaic components may be connected to a connection surface with a mechanical fastener, an adhesive, an interlocking connection with an adjacent photovoltaic module, or a combination thereof. The fasteners may be a screw, nail, bolt, staple, rivet, or a combination thereof. The adhesive may be any adhesive with sufficient strength to connect the photovoltaic components to the connection surface. The adhesive may be epoxy based, silicone based, acrylic based, a urethane based, a polyamide based, a one part adhesive, a multi-part adhesive, a natural adhesive, a synthetic adhesive, a butyl rubber, a polyolefin based adhesive, or a mixture thereof. The fastener may be a combination of a mechanical fastener and an adhesive fastener. Preferably, if an adhesive fastener is used, the connection formed by the adhesive may be broken without damaging the pv laminate, the base plate, or preferably both. An adhesive fastener may be used to connect the pv laminate to the base plate although this is not preferred as the adhesive may damage the pv laminate, the base plate, or both upon removal of the pv laminate from the base plate. The connection may be a permanent connection, a removable connection, or both so that photovoltaic components are connected to a connection surface. The photovoltaic components may be insulative such that the photovoltaic components are free of a ground wire. The photovoltaic components may be lightweight and have a low profile so that the photovoltaic components may be connected directly to the connection surface by the fastener supports, the alternative fastener supports, or both as are discussed herein. The one or more fastener supports may be located outside of the connector channels so that connectors may extend into and be removed from the connector channels.

The one or more connector channels may function to receive the one or more connectors of the pv laminate, one or more row to row connectors, one or more photovoltaic component to photovoltaic component connectors, or a combination thereof (hereinafter all referred to as connectors). The one or more connector channels may function to protect the pv laminate connectors from contact, a lateral force, a longitudinal force, an impact, or a combination thereof. The one or more connector channels may assist in forming a connection between a connector (e.g., that connects two adjacent photovoltaic modules) and connector of a pv laminate. The one or more connector channels may assist in forming a connection between a row to row connector (i.e., a connector in a row to row flashing piece) and a photovoltaic laminate. The one or more connector channels may assist in electrically connecting two adjacent pv laminate connectors, two adjacent photovoltaic components, a photovoltaic component to an inverter, or a combination thereof. The one or more connector channels may be a recess that receives the connector of the pv laminate. The one or more connector channels may be generally sloped so that the connector channels assist in forming a connection between a connector and a connector of a pv laminate. The one or more connector channels may be located on opposite edges, in opposing edge regions, on opposite sides, or a combination thereof of the base plate. The one or more connector channels may be located on a top side, a bottom side, or both of a photovoltaic component. Preferably, the connector channels are located on the top of the photovoltaic modules and on the bottom of the flashing components. The one or more connector channels may be located in a central portion of the photovoltaic component. Preferably, the connector channels are located in a central portion of a flashing component and an edge region of an active component. The one or more connector channels may receive all of the connector of the pv laminate. The one or more connector channels may angle downward so that the connector and the pv laminate are on the same plane. The one or more connector channels may be generally flat. The one or more connector channels may be “J” shaped, have a “J” shaped region, or both. The connector channels may include weep ports to remove fluids from the connector channels. The connector channels may include one or more positioning features, be located adjacent to one or more drain channels, or both. The one or more connector channels may be located proximate to one or more snap slots, lead into one or more snap slots, or both.

The one or more snap slots may function to house one or more conductors. The one or more snap slots may function to connect conductors to the bottom of a photovoltaic component. Preferably, the snap slots connect conductors to the bottom of a flashing component. The one or more snap slots may be a cut, slot, recess, tapered opening, or a combination piece that receives a portion of a conductor so that the conductor is connected to the photovoltaic component. The one or more snap slots may hold a conductor (e.g., wire) in an elevated position above an adjacent photovoltaic component. The one or more and preferably a plurality of snap slots may extend between two conductor channels. The snap slots may extend from a connector channel to an inverter. The snap slots may extend along a back of a photovoltaic component. The one or more snap slots may extend between two or more ribs, through one rib, or both.

The base plate, the photovoltaic module, active component, flashing component, photovoltaic components, or a combination thereof may include one or more and preferably a plurality of reinforcement ribs (i.e., ribs). The ribs may function to provide longitudinal support, lateral support, or both to the photovoltaic components. The ribs may function to provide support to the pv laminate, an adjacent photovoltaic component, or both. Preferably, the ribs provide support to the pv laminate when a force is applied to the active portion, the pv laminate, or both. For example, when a pv laminate is stepped on the ribs equally distribute the mass so that the pv laminate is fully supported and is not damaged. One or more ribs may extend from and be connected to the upper surface, the lower surface, or both of the photovoltaic components. The one or more reinforcement ribs may be located in the support portion, the overlap portion, a cap portion, or a combination thereof of a photovoltaic component. For example, the upper surface, the lower surface, or both and the ribs may be one integrally formed piece. The one or more ribs may be any rib that extends away from the upper surface, the lower surface, or both and provides support to one or more photovoltaic components, a photovoltaic laminate, or both. The ribs may be individual ribs that are free of contact with any adjacent ribs. Preferably, the ribs are a series of interconnected ribs that extend at angles relative to each other forming a network structure. More preferably, the photovoltaic components include a plurality of ribs and at least some of the ribs are interconnected. The ribs may form discrete closed structures, interconnected closed structures, or both. The ribs may be located on an upper surface, a lower surface, or both so that when a force is applied to the photovoltaic components the reinforcing ribs are placed in tension, in compression, or a combination of both and provide transverse stiffness, longitudinal stiffness, or both and substantially resist flexing, bending, or both of the attached active portion, an adjacent active portion, the photovoltaic component, or a combination thereof. The ribs may be located at an angle relative to each other so that when a force is applied to the photovoltaic components the ribs resist being moved towards each other, resist being moved away from each other, or both, and support the photovoltaic components

The ribs may extend at virtually any angle relative to the length and width of the photovoltaic components. One or more of the ribs may be a linear reinforcing rib. Preferably, the ribs extend at an angle relative to the length and width (i.e., are not perpendicular and/or parallel to the length and/or width). The one or more linear ribs may extend in a straight line from one edge to an opposing edge. The linear ribs may be located so that the linear ribs contact an overlap portion of an adjacent base plate, an adjacent pv laminate, or both. The linear ribs may create a flat surface for one photovoltaic components to rest upon or may form a linear surface to rest on an adjacent photovoltaic component or support structure. The angle of the ribs may extend at an angle so that the polymeric composition is disrupted in a primary direction, a secondary direction, or both. One or more ribs may be connected together and may form a geometric shape. The one or more ribs may be connected together forming a closed pattern (i.e., a reinforcement structure). The one or more ribs may be connected together forming a closed pattern and the closed pattern may be connected to an adjacent closed pattern so that a series of interconnected ribs are formed (i.e., a reinforcement structure). One or more ribs may be geometric, non-geometric, symmetrical, non-symmetrical, a circle, triangle, a polygon, a diamond, pentagon, hexagon, heptagon, octagon, nonagon, decagon, a hectogon, or a combination thereof. The one or more ribs may have a sufficient height so that a tapered surface is formed. The height of the ribs may vary along with length and/or width of the photovoltaic components so that the photovoltaic components may form a flat surface for the pv laminate, one or more adjacent photovoltaic components, may be parallel to the support structure, or a combination thereof. The one or more photovoltaic components may include one or more handles that extend through the photovoltaic component and the handles may be reinforced by the one or more ribs.

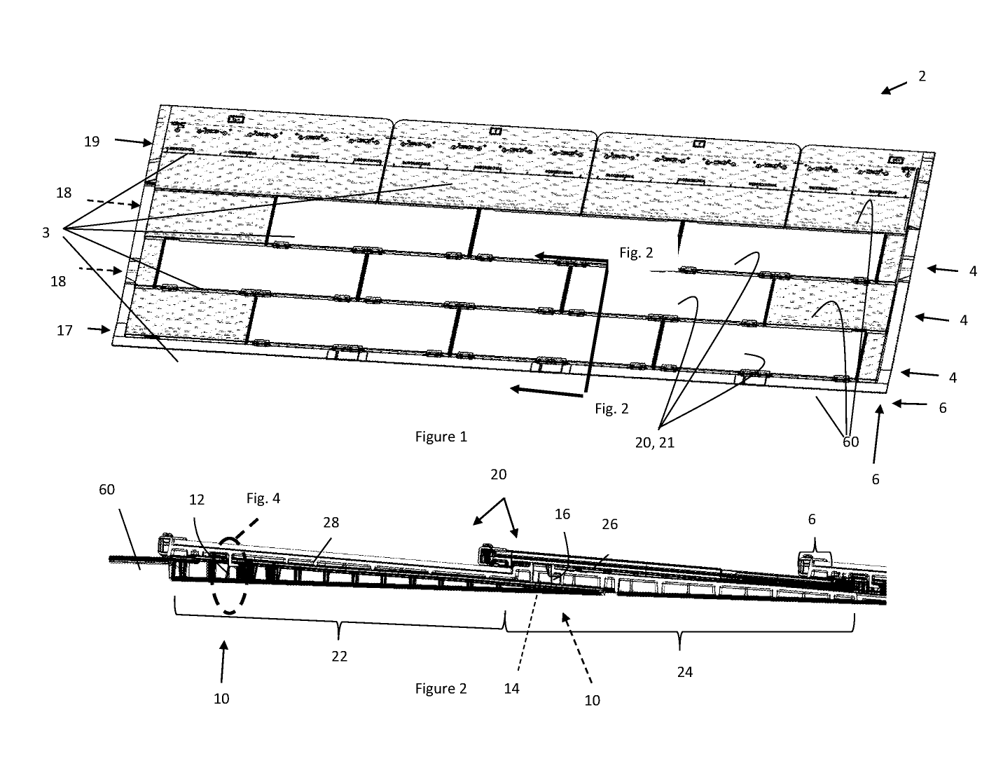

The one or more handles may function to provide a carrying location for the photovoltaic components. The one or more handles may function to provide a location to lift the photovoltaic components. The one or more handles may be a through hole through the photovoltaic components (e.g., photovoltaic module, base plate, flashing components). The one or more handles may assist in forming a connection between two or more adjacent photovoltaic components. The one or more handles may align with another structure of one or more adjacent photovoltaic components. The one or more handles may extend through one or more ribs. The one or more handles as taught herein may include teachings from U.S. Provisional Patent Application No. 61/856,125, filed on Jul. 19, 2013 the teachings of which are expressly incorporated by reference herein in their entirety and especially the teachings of paragraph nos. 0029 to 0057 and FIGS. 1-10C as to the mating features, male component, female component, through hole, and projection. The handles may be located in an overlap portion.

The overlap portion may function to receive a portion of one or more photovoltaic components. The overlap portion may function to provide support to one or more photovoltaic components. The overlap portion may be covered by a photovoltaic module, a photovoltaic component, a flashing component, or a combination thereof. The overlap portion may be directly connected to a support structure. The overlap portion may include one or more connection recesses. The overlap portion may be adjacent one or more active portions, support portion, cap portions, or a combination thereof. The active portion and the support portion may be part of the photovoltaic module as discussed herein and the cap portion may be part of the flashing component as discussed herein. The one or more photovoltaic components may include a portion that is made of a polymeric composition and the polymeric composition may include the handles, ribs, or both.

The polymeric composition of the photovoltaic components (e.g., active components and flashing components) may have low shrinkage, result in an uniform elastic modulus between a length and width, or a combination of both. The polymeric composition may be any polymeric composition that may be flowable, have high electrical insulating properties, fluid impermeable, high flexibility, low creep, low modulus, fire retardant, or a combination thereof. Some polymeric compositions that may be used with the photovoltaic module taught herein are an elastomer, thermopolastic, thermosetting polymer, or a combination thereof. The polymeric composition may include a filled or unfilled moldable plastic, polyolefins, acrylonitrile butadiene styrene (SAN), hydrogenated styrene butadiene rubbers, polyester amides, polysulfone, acetal, acrylic, polyvinyl chloride, nylon, polyethylene terephthalate, polycarbonate, thermoplastic and thermoset polyurethanes, polyethylene, polystyrene, synthetic and natural rubbers, epoxies, polystyrene, thermoplastic elastomer (TPO, TPE, TPR), polyamides, silicones, vinyl based resins, or any combination thereof. The polymeric composition may be free of fillers, fibers, reinforcing materials, or a combination thereof. The polymeric composition may include fillers such as colorants, fire retardant (FR) or ignition resistant (IR) materials, reinforcing materials, such as glass or mineral fibers, surface modifiers, or a combination thereof. The polymeric composition may also include anti-oxidants, release agents, blowing agents, and other common plastic additives. Examples of suitable polymeric compositions are found in U.S. Patent Application Publication No. 2011/0100438 the contents of which are expressly incorporated by reference herein for the polymeric compositions.

The photovoltaic components may be created by any process where the resulting structure is substantially flat and free of warp, curl, or both. The photovoltaic components may be created by compression molding, injection molding, lamination, thermoforming, rotational molding, or a combination thereof. Preferably, the photovoltaic components are produced by injection molding. During processing of the base plate the material properties of the resultant photovoltaic components may be substantially different as a result of the flow directions of the polymeric composition (i.e., longitudinal and normal (transverse) directions). These materials may result in a different elastic modulus between the length and width versus a material without the anisotropic materials, and therefore the angle of reinforcement ribs may be varied so that the elastic moduli of the length and width are substantially equal. The teachings herein may include additional teachings that may be found in U.S. Provisional Patent Application No. 61/829,680 filed on May 31, 2013, which is incorporated by reference here in its entirety and specifically paragraph nos. 0032 to 0066 and FIGS. 1-11 as to the ribs, the process of making the ribs, the composition of the ribs, and the support portion. Preferably, one of the photovoltaic components as discussed herein is a photovoltaic module and the photovoltaic module includes a base plate and a photovoltaic laminate.

The one or more base plates may function to support a photovoltaic laminate. The one or more base plates may function to protect a roofing structure from fluids. Each base plate may include a support portion, an active portion, and an overlap portion. The active portion may overlap all or a portion of one or more adjacent photovoltaic components, one or more flashing components, or both (e.g., the overlap portion) forming a “double overlap” so that each photovoltaic module may be protected and connected to a connection surface and/or so that the combined photovoltaic components may form a shingle structure for diverting fluids from the roof of the structure. Each of the photovoltaic modules may have a portion that may be indirectly and/or directly connected to a connection surface. The base plate may directly connect to a connection surface and the photovoltaic laminate may be connected to a support portion of the base plate (i.e., the photovoltaic laminate may be indirectly connected to the connection surface). Preferably, the overlap portion of each of the photovoltaic modules may be directly connected to a connection surface, and the active portion may be connected directly to the overlap portion or directly to the connection surface by a fastener that extends through the overlap portion, around the overlap portion, through a fastener support in the overlap portion, or a combination thereof. More preferably, each of the photovoltaic modules may include a base plate and a photovoltaic laminate and the base plate is connected to a connection surface by one or more fasteners that extend through fastener supports and preferably a plurality of fasteners that extend through fastener supports.

The base plate may be connected to the support structure and function to provide roofing functions. The base plate may function to connect a photovoltaic laminate (hereinafter pv laminate) to a connection surface (e.g., a roof). The base plate may function to allow for decoupled expansion and contraction of the pv laminate relative to the base plate or vice versa. The base plate may function to allow for removal, replacement, repair, or a combination thereof of the pv laminate without removal of the entire pv module from the connection surface. The base plate may function to protect all or a portion of the pv laminate. The base plate may connect the pv laminate to a connection surface. The base plate may protect one or more connectors and or wiring. The base plate may retain roofing functions, fire retardant properties, or both when the pv laminate is removed from the base plate. Preferably, the base plate may retain adequate fire retardant properties. The base plate may include one or more features to assist in forming a connection with one or more connection devices. The base plate may include one or more devices that receive a portion of a fastener, assist in forming a connection, or both. The base plate may include an active portion and an overlap portion.

The active portion may function to generate electricity when a pv laminate is connected to the base portion. The active portion may be a portion of the pv laminate that is not covered by one or more adjacent photovoltaic modules. The active portion may be a combination of a support portion of the base plate and a pv laminate.

The support portion may function to provide support to one or more pv laminates. The support portion may support one or more pv laminates during transportation. The support portion may function to support the pv laminate when a load is applied to the pv laminate when the pv laminate is connected to a connection surface. For example, when the photovoltaic module is connected to a roof and a person walks across the photovoltaic array the support portion may resist bending of the pv laminate so that the pv laminate is not damaged. The support portion may function to provide support for one or more adjacent photovoltaic modules. The support portion of a first photovoltaic module may function to overlap one or more connectors of one or more second adjacent photovoltaic modules so that the one or more connectors of the one or more second adjacent photovoltaic modules are protected. The support portion of a first photovoltaic module may protect one or more connectors that are connected to and extend between two adjacent second photovoltaic modules. The support portion may protect the laminate from penetration by foreign objects from the backside. The support portion may provide longitudinal support, lateral support, or both so that the pv laminate does not substantially deflect (i.e., enough to crack, break, or be damaged). The support portion and the pv laminate may be connected. Preferably the support portion and the pv laminate may be movable relative to each other when the pv laminate is connected to the support portion. For example, the support portion may have a coefficient of thermal expansion that is greater than that of the pv laminate and the support portion may expand relative to the pv laminate while providing support to the pv laminate. The pv laminate may be free of a fixed connection with support portion. The support portion may not provide any sealing functions to the pv laminate. The pv laminate and the support portion may be free of a sealed connection. The support portion may resist deflection and provide support to the pv laminate during loading. The support portion may function to remove fluids and/or debris away from the pv laminate. The support portion may include one or more support ribs spaced apart from one or more fluid transfer surfaces. The support portion may be part of an active component.

An active component may be any component that includes an active portion that assists in generating power. The active component may convert sunlight to electricity. The active component may function to generate power. One preferably active component is a photovoltaic module as discussed herein. Preferably, the active component is any component that includes a pv laminate.

The one or more and preferably the plurality of pv laminates may be configured in any manner so that each of the plurality of active components (e.g., photovoltaic modules) may be electrically connected. The pv laminates may include a protective cover (e.g., a glass cover or a barrier plastic cover) and at least one pv cell (e.g., an electrical circuit). Each of the individual photovoltaic modules (i.e., the pv laminates in the photovoltaic modules) may be electrically connected to an adjacent photovoltaic module by one or more connectors. The one or more connectors may comprise a ribbon, a positive buss bar, a negative buss bar, a wire, a part of an integrated flashing piece, or a combination thereof. The connector may extend between two adjacent photovoltaic modules and forms an electrical connection. The connectors may assist in securing the two or more adjacent photovoltaic modules to a support structure. Preferably, the connectors do not assist in connecting the photovoltaic modules to a support structure and the photovoltaic modules are connected to the roof structure by a fastener. Preferably, the overlap support portion is free of connectors. The connectors may be a separate piece, a discrete piece, or both that connects two or more adjacent photovoltaic modules, integrated flashing pieces, or a combination of both. The connectors may extend from an active portion of the photovoltaic module, be part of a photovoltaic module, or both. The connectors may be an integral part of a pv laminate.

The photovoltaic laminate may be connected to a base plate, a support portion of the base plate, or both and form an active portion. The photovoltaic module includes an active portion and a support portion. The active portion and the support portion may be the same region of the base plate. The active portion may be any portion of the photovoltaic module that produces electricity when the active portion is in contact with sunlight. The pv laminate may be made of any material so that when sunlight is directed on the active portion the sunlight is converted into electricity. The pv laminate may be made of one or more photovoltaic cells having a photoactive portion. Preferably, the pv laminate may be made of a plurality of photovoltaic cells. The photovoltaic cells may be made of any material that assists in converting sunlight into electricity. The photovoltaic cells may be of any type and material known in the art. Some non-limiting examples of materials that the photovoltaic cells may be made of include crystalline silicon, amorphous silicon, cadmium telluride (CdTe), gallium arsenide (GaAs), copper chalcogenide type cells (e.g. copper gallium selenides, copper indium gallium selenides (CIGS), copper indium selenides, copper indium gallium sulfides, copper indium sulfides (CIS), copper indium gallium selenide sulfides, etc. (i.e., known generally as CIGSS)), thin-film III-V cells, thin-film II-VI cells, IB-IIIA-chalcogenide (e.g., IB-IIIA-selenides, IB-IIIA-sulfides, or IB-IIIA-selenide sulfides), organic photovoltaics, nanoparticle photovoltaics, dye sensitized photovoltaic cells, and/or combinations of the described materials. In one specific example, the copper indium gallium selenides may be represented by the formula CuIn(1-x)GaxSe(2-y)Sy where x is 0 to 1 and y is 0 to 2. For copper chalcogenide type cells, additional electroactive layers such as one or more of emitter (buffer) layers, conductive layers (e.g. transparent conductive layers) or the like maybe used in CIGSS based photovoltaic cells are contemplated by the teachings herein. The active portion may be flexible or rigid and come in a variety of shapes and sizes, but generally are fragile and subject to environmental degradation. In a preferred embodiment, the active portion is a cell that can bend without substantial cracking and/or without significant loss of functionality. Other materials and/or combinations are contemplated herein especially those compositions disclosed in paragraph 0054 of U.S. Patent Application Publication No. 2012/0118349, which is incorporated herein by reference as to materials for the active portion. The photovoltaic cells of the photovoltaic laminate may be arranged in parallel, series, mixed series-parallel, and/or may be provided in independent circuits. The photovoltaic laminate may be a combination of layers and may form an assembly.

The pv laminate assembly may include one or more of the following components: a forward protective layer, a rearward protective layer, a reinforcement, a photovoltaic cell, a peripheral moisture sensitive edge seal, one or more internal protecting layers, dielectric materials as may be needed to manage the penetration of electrical components outside the laminate, attached connectors and wiring boxes, connector support structures including junction boxes, integrated low profile connectors, encapsulants, moisture resistant back sheets that may optionally include metallized sub layers, or a combination thereof. One example of a pv laminate may include a top layer of glass or a polymeric moisture barrier, an encapsulant layer, an electrical assembly comprising cells, bypass diodes and busses, a rear encapsulant layer, an aluminum based multi-layer back sheet, another encapsulant layer, a rearward protective layer, additional layers around the connector area including a connector support structure, an encapsulant, a dielectric layer, a connector sealant material such as an adhesive with a moisture barrier or another adhesive sealant or potting material, the low profile connector attached to the cells with bus terminals, another layer of encapsulant, and another dielectric layer. The rearward protective layer may help protect the laminate from any protrusions or abrasion from the support structure of the base plate. The pv laminate assembly may be free of an encapsulant layer, a rearward protective layer, or both. One or more of the layers discussed herein may be a combination of layers. For example, a forward protective layer may be a combination of multiple glass layers combined together. As another example, the reinforcement may be a plurality of layers bonded together. The layers of pv laminate assembly may be laminated together. The layers of the pv laminate may be sealed at the edges. Preferably, the pv laminate has a peripheral sealed edge that is resistant to fluid penetration. As discussed herein, each individual layer may include an adhesive so that one or more layers are bonded together forming a layer, each layer may include an adhesive over and/or under another layer so that the one or more adjacent layers are bonded together. Other components and layers of the photovoltaic module are contemplated herein that may be used with the reinforcement taught herein especially those components, layers, and/or materials disclosed in Paragraph Nos. 0048-0053 of U.S. Patent Application Publication No. 2012/0118349, and Paragraph Nos. 0027-0038 and FIGS. 2A and 2B 2011/0220183, both of which are expressly incorporated herein by reference as to components, layers, and/or materials for active portions that may be used in conjunction with the reinforcement and photovoltaic module discussed herein. One or more of the layers of the pv laminate may be electrical circuitry. The electrical circuitry may be sealed within the pv laminate.

The electrical circuitry of the photovoltaic laminate may be one or more buss bars, one or more ribbons, or both. The electrical circuitry may extend from cell to cell, photovoltaic module to photovoltaic module, cell to a photovoltaic module, active portion to active portion, or a combination thereof. The electrical circuitry may be integrated into the one or more photovoltaic cells, connect the one or more photovoltaic cells, be electrically connected to the one or more photovoltaic cells, or a combination thereof. The electrical circuitry may be integrated into and/or around one or more layers of the photovoltaic laminate. The electrical circuitry may extend through the photovoltaic laminate, extend partially outside of the photovoltaic laminate so that an electrical connection may be formed, have a portion that is located adjacent to the photovoltaic laminate, or a combination thereof. The photovoltaic laminate may be connected to a support portion of a base plate forming an adjacent portion. The pv laminate may include one or more connectors that are part of the electrical circuity and extend outside of the pv laminate. The one or more connectors may have a portion that is sealed within the pv laminate and a portion that extends out of the pv laminate. The one or more connectors may be covered by one or more active components, one or more flashing components, or both.

The one or more flashing components may function to create a fluid impenetrable barrier. The one or more flashing components may function to cover one or more active components and prevent fluid from entering the photovoltaic array. The one or more flashing components may end one or more rows. The one or more flashing components may connect two or more rows. The one or more flashing components may have a portion that extends under an active component, under a standard roofing shingle, over an active component, over a standard roofing shingle, or a combination thereof. The one or more flashing components may form a cap over one or more photovoltaic components. The one or more flashing components may be free of any active portion, any portion that produces power, or both. The one or more flashing components may protect the active components. The one or more flashing components may connect one or more rows of active components together. The one or more flashing components may cover one or more through holes, handles, connection recesses, or a combination thereof in the active components, in other flashing components, or both. The one or more flashing components may prevent wind uplift. The one or more flashing components may create a tortuous path for water to enter the photovoltaic array in a direction opposite the slope of the roof. The one or more flashing components may seal the peripheral edge of the photovoltaic array. The edge of one or more of the flashing components may include one or more side ledges.

The flashing components may include one or more side ledges. Some of the flashing components may include one or more side ledges. Some of the flashing components may be free of side ledges. Flashing components may include a plurality of side ledges. The side ledges may extend the length of or more of the edges of the flashing components. Preferably, the side ledges extend less than the length of one or more edges of the flashing components. The side ledges may connect to an adjacent side ledge to form a fluid barrier. The side ledges may mate with the standard shingles. The side ledges may taper between the top of the photovoltaic array and the standard shingles. A portion of the side ledges may extend under the standard shingles. A portion of the side ledges may extend over and into contact with the standard shingles (e.g., asphalt shingles, stucco shingles, clay shingles). The side ledges may be in communication with each other and form a peripheral edge around the photovoltaic array. The side ledges may prevent water from creeping under the flashing components, the active components, or both. The side ledges may overhang the photovoltaic array, a standard shingle, or both. The one or more side ledges may extend from cap portions of a flashing component. The side ledges may be proximate to or opposite one or more flashing interfaces. Preferably, when a flashing component includes a side ledge, the component does not include a flashing interface.

The one or more flashing interfaces may function to interface with standard shingles, roofing material, or both. The one or more flashing interfaces may prevent fluid from extending from the roof onto the photovoltaic array. The one or more flashing interfaces may guide water along a side of the photovoltaic array without the water entering onto the photovoltaic array. The flashing interface may overlap a standard shingle, a roofing material, or both. The flashing interface may be overlapped by a standard shingle, a roofing material, or both. The flashing interface may receive an adjacent photovoltaic component, an adjacent flashing component, a photovoltaic module, or a combination thereof. The flashing interface may extend over standard roofing shingles at some locations and under standard roofing shingle in other locations. The flashing interface may interface within a row, with a row below, or both. The flashing interface may prevent water from entering the photovoltaic array. The flashing interface may be located under a side ledge, adjacent a side ledge, under a side ledge of a different photovoltaic component, or a combination thereof. The flashing interface may be flat, taper away from the photovoltaic array, angle away from the photovoltaic array, be located on a peripheral edge, or a combination thereof. A corner flashing piece may include two flashing interfaces. A center flashing piece may include one flashing interface. A row to row flashing piece may include one or more or even two or more flashing interfaces. The one or more flashing interfaces may include one or more ramps.

The one or more ramps may function to create a transition on the one or more photovoltaic components. The one or more ramps may move a flashing interface from extending over a standard shingle to under a standard shingle or vice versa. The one or more ramps may be a transition along one or more edges. The one or more ramps may assist in creating a fluid barrier. The one or more ramps may partially cover one or more roofing components and be partially covered by one or more roofing components. The one or more ramps may partially cover a standard roofing shingle and/or partially be covered by a standard roofing shingle. The one or more ramps may increase the size of the flashing walls so that the flashing walls prevent fluid from entering the photovoltaic array. The flashing interfaces may terminate at one or more flashing walls.

The one or more flashing walls may function to prevent fluid from ingress into the photovoltaic array. The one or more flashing walls may function to create a barrier that is taller than a standard roofing shingle, a roofing material, or both. The one or more flashing walls may prevent wind from blowing water under one or more photovoltaic components, blowing water from a standard roofing shingle unto the photovoltaic array, or both. The one or more flashing walls may be sufficiently tall that fluid cannot move from the standard roofing portion to the photovoltaic array. The one or more flashing walls may form an interface with the standard roofing shingles so that water cannot penetrate into the photovoltaic array. One or more edges of the photovoltaic array may include two or more flashing walls. One or more edges of the photovoltaic array may include a single flashing wall. The flashing interface may extend over standard roofing shingles at some locations and under standard roofing shingle in other locations. The flashing walls may terminate the flashing interfaces. The flashing walls may terminate at a flashing extension.

The one or more flashing extensions may function to form an overlapped connection with an adjacent flashing component. The one or more flashing extensions may function to create a water tight connection between two adjacent flashing components. The one or more flashing extensions may function as a locating feature, a partial locating feature, or both. The one or more flashing extensions may align with a flashing extension of another photovoltaic component. The one or more flashing extensions may interlock with a flashing extension of another flashing component. One flashing extension may align with a pocket of an adjacent photovoltaic extension. The flashing extensions prevent rain from being driven up the photovoltaic array and under the one or more photovoltaic components. The one or more flashing extensions may extend under a flashing extension of an adjacent flashing component, under a main portion of a flashing component, or both. The one or more flashing extensions may extend over a flashing extension of an adjacent flashing component, under a main portion of a flashing component, or both. The one or more flashing extensions may extend the flashing interface beyond a main edge of the flashing component. The one or more flashing extensions may be rectangular, square, triangular, semi-circular, a rhombus, symmetrical, asymmetrical, or a combination thereof. The one or more flashing extensions may interlock, overlap, abut, or a combination thereof with another flashing extension. The one or more flashing extensions may be located on starter row components only (i.e., the first row of photovoltaic components that are placed on a roof structure). The one or more flashing extensions may be located on edge components, cap components, or both. Preferably, the flashing extensions of the flashing components are free of flashing extensions. A flashing component may include one or more or two or more flashing extensions. When more than one flashing extension is present it is preferred that one is a male flashing extension and one is a female flashing extension. Some flashing extensions may be male flashing extensions and other flashing extensions may be female flashing extensions. The male flashing extensions may extend over an adjacent flashing extension or flashing component and align with a pocket. The female flashing extensions may include a pocket that receives and forms a connection with a male flashing extension.

The one or more pockets may function to create a water tight connection with an adjacent flashing extension. The one or more pockets may receive an adjacent flashing extension. The one or more pockets may include one or more flashing walls. The one or more pockets may be formed in the flashing interface, above the flashing interface, partially in the flashing interface, and partially adjacent to the flashing interface, or a combination thereof. The one or more pockets may be a recess that receives a flashing extension so that the flashing extension is flush with the other photovoltaic components. The one or more pockets may include one or more steps that mirror steps on the flashing extensions. The one or more pockets may be located on starter row components only (i.e., the first row of photovoltaic components that are placed on a roof structure). The one or more pockets may be located on edge components, cap components, or both. Preferably, the cap portions of the flashing components are free of pockets.

The one or more cap portions may function to cover one or more through holes, recesses, or both. The one or more cap portions may function to prevent fluid from penetrating into the photovoltaic array. The one or more cap portions may be a final row of a photovoltaic array. The one or more cap portions may complete a final row, be a top layer of a row, a top layer of the photovoltaic array, or a combination thereof. The one or more cap portions may overlap one or more photovoltaic components. The one or more cap portions may be free of through holes, handles, connection recesses, fastener locations, alternative fastener locations, or a combination thereof. The one or more cap portions may be substantially solid.

The one or more cap portions may include one or more connection hooks for forming a connection with an adjacent photovoltaic component. The one or more cap portions may include one or more alignment slots, alignment ribs, or both for alignment with the one or more adjacent photovoltaic components. The one or more cap portions may be the only portion of a flashing component. The one or more cap portions may include one or more cap extensions that extend over a portion of a second row, an adjacent row, or both.

The one or more cap extensions may function to extend a cap portion from a first row to a second row. The one or more cap extensions may extend from a top row to a row below the top row. The one or more cap extensions may create a fluid barrier that covers a seam between two rows. The one or more cap extensions may form a connection with a row to row flashing piece, a row to row connection portion, or a combination thereof. The one or more cap extensions may create a generally “L” shaped section. The one or more cap extensions may be located below a plane of a cap portion. The one or more cap extensions may be located in the same plane as the cap portion. The one or more cap extensions may be located at an edge of a photovoltaic array. The one or more cap extensions may complete a row to row connection. The one or more cap extensions may include any of the features of the cap portion and may perform any of the functions of the cap portions. The one or more cap extensions may be smaller than the one or more cap portions. The one or more cap portions, one or more cap extensions, or both may be free of an alignment rib, an alignment slot, or both.

The one or more alignment ribs may function to align one or more photovoltaic components relative to each other. The one or more alignment ribs may prevent one photovoltaic component from moving relative to another photovoltaic component. The one or more alignment ribs may extend under and/or over an adjacent photovoltaic component. Preferably, the one or more alignment ribs extend from an upper surface of a photovoltaic component. More preferably, the one or more alignment ribs extend from an upper surface of a row to row connector portion. The alignment ribs may be located only on row to row flashing pieces. The alignment ribs may be located on corner flashing pieces, center flashing pieces, or both. The corner flashing pieces, the center flashing pieces, or both may be free of alignment ribs. The one or more alignment ribs may be a linear piece that extends vertically above a top surface of a flashing component. The one or more alignment ribs may be linear, serpentine, include one or more bends, include one or more curves, or a combination thereof. The one or more alignment ribs may provide a feature that forms a complementary fit with one or more alignment slots of an adjacent photovoltaic component.

The one or more alignment slots may function to receive an alignment rib to align two photovoltaic components relative to each other. The one or more alignment slots may form a complementary fit with one or more alignment ribs. The one or more alignment slots may prevent movement of a photovoltaic component that includes an alignment rib when the alignment slot and alignment rib are in communication. The one or more alignment slots may be a region formed between ribs, through ribs, by an absence of ribs, or a combination thereof. The one or more alignment slots may be located entirely on a bottom side of a photovoltaic component and preferably a flashing component. A portion of the alignment slot may form a raised portion on a top side of a photovoltaic component and preferably a flashing component. The one or more alignment ribs may extend along a length, a width, diagonally, in a straight line, a curved line linearly, include one or more bends, include one or more curves, or a combination thereof. Preferably, whatever the shape of the alignment slots are the alignment ribs are the same shape and vice versa. Preferably, the alignment slots and the alignment ribs have complementary shapes. The alignment slots may be located on a bottom side so that when a photovoltaic component extends over another photovoltaic component the alignment rib extends into the alignment slot. The one or more alignment slots may be located in one or more cap portions, one or more flashing components that include a cap portion, or both. The one or more alignment slots may be located in a flashing piece when the flashing piece is a standard piece, a plus piece, a minus piece, or a combination thereof.

The one or more standard pieces may function to assist in collecting sunlight and creating power. The one or more standard pieces may be a standard size. The one or more standard pieces may be sized so that one piece may form a partial overlap of at least two pieces. The standard piece may have a length (X) and a width (Y). Length when discussed herein is the distance along the slope and width is the direction transverse to the length. The standard pieces may have a width that is less than the plus pieces and is greater than the minus pieces.

The plus pieces may function to fill a gap created by one or more pieces being offset. The plus pieces may function to fill a gap that is wider than a standard gap. The photovoltaic array may include one or more plus pieces. The photovoltaic array may include a plurality of plus pieces. One or more rows may include one or more plus pieces. The length of the plus piece may be the same as a standard piece and a minus piece (i.e., X). The photovoltaic components may have a standard length, a minus length, a plus length, or a combination thereof. The length of a plus length piece may be about 1.2X or more, about 1.5X or more, or even about 1.8X or more. The length of the plus piece may be about 4X or less, about 3X or less, or about 2X or less. The plus length piece may function to extend fully or partially between two or more rows. The plus length piece may fully cover a minus length piece and fully or partially cover a standard length piece. The plus length piece may electrically connect two adjacent rows. The length of a minus length piece may be about 0.8X or less, about 0.7X or less, or about 0.5X or less. The length of a minus length piece may be about 0.3X or more, about 0.4X or more, or even about 0.45X or more. The minus length piece may function to only receive a portion of a length of a standard piece, or a plus length piece so that the standard piece, the plus length piece, or both covers all of the minus length piece and a portion of a piece in an adjacent row. The minus length piece may be a base piece. The plus pieces may have a greater length due to the addition of a row to row connector portion, a cap extension, a flashing extension, or a combination thereof. The length and width of the photovoltaic components may include the flashing interfaces, the flashing extensions, or both. Preferably, the length and the width of the photovoltaic components is the body portion. More preferably, the length and width of the photovoltaic components is measured without measuring the flashing interface, the flashing extension, or both.

The width of the plus piece may be greater than a standard piece. The width of a plus piece may be about 1.1Y or more, about 1.2Y or more, about 1.3Y or more, or even about 1.5Y or more. The width of a plus piece may be about 2Y or less, about 1.8Y or less, or even about 1.7Y or less than a standard piece. The width of a plus piece relative to a minus piece may be about 1.5Y or more, about 1.7 or more, or even about 1.8Y or more. The width of a plus piece relative to a minus piece may be about 2.5Y or less, about 2.3Y or less, or about 2Y or less. The plus piece may have a portion that extends between two adjacent rows. Preferably, the plus piece extends over at least a portion of two adjacent photovoltaic components. The plus piece may include one or more cap portions. The plus piece may be a corner flashing piece. The plus piece may be a row to row flashing piece. The plus piece may be a center flashing piece. Preferably, the plus pieces are corner flashing pieces. The plus pieces may assist in creating a step out, a step in, or both. The plus pieces may be located in the same row as a minus piece so that the offset of the pieces is compensated for and a square, rectangular, symmetrical, or a combination thereof photovoltaic array is created. A row may include an equal number of plus pieces as minus pieces.

The one or more minus pieces may function to fill in a gap created by one or more pieces being offset within a row. The one or more minus pieces may fill in a gap created by one or more plus pieces being installed. The one or more minus pieces may fill in a gap created by a row to row connector. The photovoltaic array, a row, or both may include one or more minus pieces. The photovoltaic array, a row, or both may include a plurality of minus pieces. The minus pieces may extend within a single row. The minus pieces may extend within multiple rows. The minus pieces may be a cap portion, a flashing component, a corner flashing piece, a center flashing piece, a row to row flashing piece, or a combination thereof. The one or more minus pieces relative to a standard piece may have a width that is about 0.5Y or more, about 0.6Y or more, about 0.7Y or more, or even about 0.75Y or more. The one or more minus pieces relative to a standard piece may have a width that is about Y, about 0.9Y or less, or about 0.8Y or less. The one or more minus pieces may assist in maintaining all of the rows the same length. The one or more minus pieces may assist in forming a photovoltaic array that is square, rectangular, symmetrical, or a combination thereof. The one or more minus pieces may assist in creating a step in, a step out, or both. The one or more minus pieces may be preferably a row to row flashing piece, a corner flashing piece, or a combination of both.

The one or more corner flashing pieces may function to terminate one or more rows. The one or more corner flashing pieces may be located in a corner of the photovoltaic array. The one or more corner flashing pieces may include at least two flashing interfaces. The flashing interfaces on a corner flashing piece may be at an angle relative to each other. The angle of the flashing interfaces on a corner flashing piece may be about 60 degrees or more, about 75 degrees or more, or even about 85 degrees or more from each other (i.e., about 90 degrees). The angle of the flashing interfaces on a corner flashing piece may be about 135 degrees or less, about 115 degrees or less, or even about 105 degrees or less from each other. The one or more corner flashing pieces may interface with standard roofing shingles on two or more edges. The one or more corner flashing pieces may include one or more flashing extensions. The one or more corner flashing pieces may have a portion that extends under one or more adjacent flashing pieces, one or more center flashing pieces, one or more row to row flashing pieces, one or more standard shingles, or a combination thereof. The one or more corner flashing pieces may be a portion of a starter row, a portion of an ending row, or both. The one or more corner flashing pieces may not be located within internal rows. The one or more corner flashing pieces may be part of an internal row when the photovoltaic array includes a step in, a step out, or both. The one or more corner flashing pieces may be a top right, top left, bottom right, bottom left, minus piece, plus piece, standard piece, or a combination thereof.

The top right minus piece, top right plus piece, or both may function to form a portion of an ending row. The top right minus piece, top right plus piece, or both may function to cap a portion of a row. The top right minus piece, top right plus piece, or both may entirely be a cap portion or a cap portion and a cap extension. The top right minus piece, top right plus piece, or both may include one or more side ledges. The side ledges may be on one or more edges of the top right minus piece, top right plus piece, or both. The top right minus piece, top right plus piece, or both may include one or more alignment slots. The top right minus piece may have a width that is less than a standard piece (e.g., the top right minus piece may have any of the dimensions discussed herein as to a minus piece). The top right plus piece may have a width that is greater than a standard piece (e.g., the top right plus piece may have any of the dimensions discussed herein as to a plus piece). The top right minus piece, top right plus piece, or both may extend over a portion of a photovoltaic module, a portion of a row to row connector, or both. The top right minus piece, top right plus piece, or both may be free of through holes. The top right minus piece, top right plus piece, or both may include one or more and preferably a plurality of connection hooks. The top right minus piece, top right plus piece, or both may extend over a row to row connection portion, over an alignment rib, or both. The top right minus piece, top right plus piece, or both may be free of a flashing extension. The top right minus piece, top right plus piece, or both may extend in only one row. The top right minus piece, top right plus piece, or both may extend in two or more rows. The top right minus piece may be used instead of a top right plus piece or vice versa. The top right minus piece, the top right plus piece, or both may be located on opposite edges of the photovoltaic array as a top left minus piece, a top left plus piece, or both. Preferably, when a top right plus piece is used on one edge a top left minus piece is used on the opposing edge. Correspondingly, when a top right minus piece is used on one edge a top left plus piece is used on the opposing edge.

The top left minus piece, top left plus piece, or both may function to form a portion of an ending row. The top left minus piece, top left plus piece, or both may function to cap a portion of a row. The top left minus piece, top left plus piece, or both may be a cap or a cap and cap extension. The top left minus piece, top left plus piece, or both may include one or more side ledges. The side ledges may be on one or more edges of the top left minus piece, top left plus piece, or both. The top left minus piece, top left plus piece, or both may include one or more alignment slots. The top left minus piece may have a width that is less than a standard piece (e.g., the top left minus piece may have any of the dimensions discussed herein as to a minus piece). The top left plus piece may have a width that is greater than a standard piece (e.g., the top left plus piece may have any of the dimensions discussed herein as to a plus piece). The top left minus piece, top left plus piece, or both may extend over a portion of a photovoltaic module, a portion of a row to row connector, or both. The top left minus piece, top left plus piece, or both may be free of through holes. The top left minus piece, top left plus piece, or both may include one or more and preferably a plurality of connection hooks. The top left minus piece, top left plus piece, or both may extend over a row to row connection portion, over an alignment rib, or both. The top left minus piece, top left plus piece, or both may be free of a flashing extension. The top left minus piece, top left plus piece, or both may extend in only one row. The top left minus piece, top left plus piece, or both may extend in two or more rows. The top left minus piece may be used instead of a top left plus piece or vice versa. The top left minus piece, top left plus piece, or both may be located on opposite edges of the photovoltaic array as a top right minus piece, a top right plus piece, or both.

The bottom left plus piece, bottom left minus piece, bottom right plus piece, bottom right minus piece, or a combination thereof may function to terminate one or more rows. The bottom left plus piece, bottom left minus piece, bottom right plus piece, bottom right minus piece, or a combination thereof form a terminal piece. The bottom left plus piece, bottom left minus piece, bottom right plus piece, bottom right minus piece, or a combination thereof may be a base piece that begins a row, begins the photovoltaic array, or both. The bottom left plus piece, bottom left minus piece, bottom right plus piece, bottom right minus piece, or a combination thereof may be entirely directly connected to a support structure and the pieces in an adjacent row may overlap a portion and build off of the bottom left plus piece, bottom left minus piece, bottom right plus piece, bottom right minus piece, or a combination thereof. The bottom left plus piece, bottom left minus piece, bottom right plus piece, bottom right minus piece, or a combination thereof may be part of a starter row, may form opposing edges of a starter row, or both. The bottom left plus piece, bottom left minus piece, bottom right plus piece, bottom right minus piece, or a combination thereof may include one or more side ledges. Preferably, the bottom left plus piece, bottom left minus piece, bottom right plus piece, bottom right minus piece, or a combination thereof each include at least two side ledges that are on opposing edges. The bottom left plus piece, bottom left minus piece, bottom right plus piece, bottom right minus piece, or a combination thereof may include only connection recesses, be free of connection hooks, or both. The bottom left plus piece, bottom left minus piece, bottom right plus piece, bottom right minus piece, or a combination thereof may include one or more flashing interfaces. The one or more flashing interfaces each extend along one or more walls. Preferably, the bottom left plus piece, bottom left minus piece, bottom right plus piece, bottom right minus piece, or a combination thereof each include a flashing interface along two edges. The bottom left plus piece, bottom left minus piece, bottom right plus piece, bottom right minus piece, or a combination thereof may include one or more flashing walls and preferably at least one edge includes two or more flashing walls. The bottom left plus piece, bottom left minus piece, bottom right plus piece, bottom right minus piece, or a combination thereof may include one or more flashing extensions. When a bottom left plus piece is installed a bottom right minus piece may be installed. Conversely, when a bottom right plus piece is installed a bottom left minus piece may be installed. The bottom right pieces (plus or minus) may be located on opposite edges as the bottom left pieces (plus or minus). The bottom left plus piece, bottom left minus piece, bottom right plus piece, bottom right minus piece, or a combination thereof may be used in a row other than the starter row. The bottom left plus piece, bottom left minus piece, bottom right plus piece, bottom right minus piece, or a combination thereof may be part of a step in, a step out, or both. The bottom left plus piece, bottom left minus piece, bottom right plus piece, bottom right minus piece, or a combination thereof may be in communication with a center flashing piece, also the top right plus piece, top right minus piece, top left plus piece, top left minus piece, or a combination thereof may be in communication with one or more center flashing pieces.

The one or more center flashing pieces may function to extend between edges of a photovoltaic array. The one or more center flashing pieces may provide support for one or more active components. The one or more center flashing pieces may cap one or more active components. The one or more center flashing pieces may be part of a starter row, an ending row, or both. The one or more center flashing pieces may connect to another center flashing pieces, a corner flashing piece, or both. The one or more center flashing pieces may include one or more flashing interfaces. The one or more center flashing pieces may include one or more flashing extensions. The one or more center flashing pieces may include a flashing extension on a first side, a second side, or both sides. The one or more center flashing pieces may include one or more flashing walls. Preferably, the center flashing pieces include at least two flashing walls. The one or more center flashing pieces include a peripheral edge and the connection members may be located inside of the peripheral edge. The one or more center flashing pieces may include only connection hooks or only connection recesses. The one or more center flashing pieces may include one or more pockets. Preferably one flashing extension includes a pocket and one flashing extension is free of a pocket. The one or more center flashing pieces may be a bottom piece, a top piece, or both.

The one or more bottom pieces may function to connect to a support structure. The one or more bottom pieces may function to extend between two corner pieces. The one or more bottom pieces may include a row of connection members. Preferably, the one or more bottom pieces may include a row of connection recesses (e.g., a plurality of connection recesses). The one or more bottom pieces may form an interface with standard shingles. The one or more bottom pieces may form the base for the entire photovoltaic array. The one or more bottom pieces may form a base connection structure. The one or more bottom pieces may be located opposite a top piece.

The one or more top pieces may function to cap the photovoltaic array. The one or more top pieces may function to cover one or more connection recesses, one or more handles, one or more through holes, or a combination thereof of one or more photovoltaic components. The one or more top pieces may include only connection hooks. The one or more top pieces may include one or more openings. The one or more top pieces may receive one or more doors. The one or more top pieces may extend between the edges of the photovoltaic array without extending to the edge of the photovoltaic array. The one or more top pieces may be free of contact with a row to row flashing piece.

The one or more row to row flashing pieces may extend between two or more rows. The one or more row to row flashing pieces may function to physically connect, electrically connect, or both two or more adjacent rows. The row to row flashing pieces may electrically connect a first row to a second row. The row to row flashing pieces may extend between two or more rows or three or more rows. The row to row flashing pieces may electrically connect two rows and cap a portion of one row while providing a support structure for a portion of another row. The row to row flashing pieces may include a cap portion, an overlap portion, or both. The row to row flashing pieces may be a corner piece as well as a row to row flashing piece. The row to row flashing pieces may include one or more flashing interfaces, one or more flashing walls, one or more flashing extensions, or a combination thereof. The row to row flashing pieces may include a plurality of connection members. The row to row flashing pieces may include connection hooks, connection recesses, or both. The row to row flashing pieces may include a row to row connection portion. The row to row connection portion may extend between a first row and a second row. A row to row connector portion may separate two portions of a row to row flashing piece. For example, the row to row connector portion may separate a cap portion and an overlap portion, separate two cap portions, separate two overlap portions, or a combination thereof. The row to row flashing pieces may include one or more connector channels and preferably two connector channels. One connector channel may be located in a row to row connection portion and the other connector channel may be located in an overlap portion, a cap portion, or both. The row to row flashing pieces may include a plurality of ribs. The ribs may include one or more and preferably a plurality of snap slots that extend between and connect two connector channels, a connector channel and a through roof connection, or both. The row to row flashing pieces may include one or more alignment ribs, one or more alignment slots, or both. The row to row flashing pieces may be located on a right side, a left side, or both. The right side pieces may be a reverse mirror image to the left side pieces. The row to row flashing pieces may be a left piece, left minus piece, a left plus piece, a right piece, a right minus piece, a right plus piece.

The bottom left minus piece, a bottom left plus piece, a bottom right minus piece, a bottom right plus piece, or a combination thereof may function to connect a bottom row to an adjacent row. The bottom left minus piece, a bottom left plus piece, a bottom right minus piece, a bottom right plus piece, or a combination thereof may extend over a corner flashing piece, a bottom flashing piece, or both. The bottom left minus piece, a bottom left plus piece, a bottom right minus piece, a bottom right plus piece, or a combination thereof may include a row to row connector portion that extends from the first row to a second row. For example, the row to row connector portion may extend from the starter row to the next adjacent row. The bottom left minus piece, a bottom left plus piece, a bottom right minus piece, a bottom right plus piece, or a combination thereof may form both a base part of the starter row and extend to an adjacent row. The bottom left minus piece, a bottom left plus piece, a bottom right minus piece, a bottom right plus piece, or a combination thereof may have the row to row connector portion on the right side (if a right piece) or the left side (if a left piece). The bottom left minus piece, a bottom left plus piece, a bottom right minus piece, a bottom right plus piece, or a combination thereof may form a connection with a standard shingle, an overlap with a shingle, or both. The minus pieces and the plus pieces include one or more of the features taught herein and incorporated by reference into the teachings of the bottom left minus piece, a bottom left plus piece, a bottom right minus piece, a bottom right plus piece, or a combination thereof. If a row has a bottom right piece (plus or minus) the row does not include a bottom left piece (plus or minus) or vice versa. For example, if a photovoltaic array includes a bottom right minus piece that connects the first row and the second row, then the left side does not have a bottom left minus piece and has a left piece that connects the second row to the third row. The bottom left minus piece, a bottom left plus piece, a bottom right minus piece, a bottom right plus piece, or a combination thereof preferably, have a cap portion, an overlap portion, or both on one side of a row to row connector portion. The bottom left minus piece, a bottom left plus piece, a bottom right minus piece, a bottom right plus piece, or a combination thereof may be free of a cap portion, an overlap portion, or both on both sides of the row to row connector portion.

The step in right pieces, step in left pieces, or both may function to create a non-square or non-rectangular photovoltaic array. The step in right pieces, step in left pieces, or both may function to shift to accommodate a roofing structure. The step in right pieces, step in left pieces, or both may terminate one row and extend a row. The step in right pieces, step in left pieces, or both may shift a row to one side. The step in right pieces, step in left pieces, or both may have a portion that extends over one row and may have an overlap portion that extends under another row. The step in right pieces, step in left pieces, or both may include connection hooks and connection recesses. The step in right pieces, step in left pieces, or both may extend a right side or a left side respectively of a photovoltaic array. The step in right pieces, step in left pieces, or both may include one or more openings. The step in right pieces, step in left pieces, or both preferably include at least two connector channels for receiving a connector from one or more rows. The step in right pieces, step in left pieces, or both may include a row to row connector portion that extends between two halves. The step in right pieces, step in left pieces, or both may connect two or more internal rows. The step in right pieces, step in left pieces, or both may be located opposite or be used in lieu of a left piece, a right piece, or both.

The one or more left pieces, one or more right pieces, or both may function to connect two or more internal rows. The one or more left pieces, one or more right pieces, or both may be located on edges of the photovoltaic array. The one or more left pieces, one or more right pieces, or both may connect a second row to a third row or a third row to fourth row. The one or more left pieces, one or more right pieces, or both may connect an internal row to an ending row. The one or more left pieces, one or more right pieces, or both may have a row to row connector portion that extends along the peripheral edge of the photovoltaic array. The one or more left pieces, one or more right pieces, or both may have a cap portion that extends over a photovoltaic component, an overlap portion that extends under a photovoltaic component, or a combination of both. A right piece and a left piece may not be located directly opposite each other. For example, a right piece connections row two and row three and the left piece connects row three and row four. The right piece and the left piece may be staggered from row to row so that the electrical circuitry extends in a serpentine manner. The one or more left pieces, one or more right pieces, or both may include one or more connector hooks, one or more connector recesses, or both. The one or more left pieces, one or more right pieces, or both may include one or more flashing interfaces, one or more flashing extensions, or both. The one or more left pieces, one or more right pieces, or both may include one or more alignment ribs, one or more alignment slots or both. Preferably, the alignment ribs are located on the row to row connector portion.

The row to row connector portion may function to electrically connect, physically connect, or both, two adjacent rows. The row to row connector portion may have two connector channels that connect two rows. The row to row connector portion may include one connector channel and the connector channel may be electrically connected to an adjacent connector channel so that power is transferred between two adjacent rows. The row to row connector portion may include one or more flashing interfaces, flashing walls, flashing extensions or a combination thereof. The row to row connector portion may be free of any connection members. The row to row connector portion may include one or more connection hooks, one or more connection recesses, or both. The row to row connector portion may include one or more fastening locations. The row to row connector portion may include one or more alignment ribs, one or more alignment slots, or both. The row to row connector portion may include one or more ribs, one or more snap slots, or both. The row to row connector portions may be located proximate to one or more openings in the photovoltaic components.

The one or more openings may function to provide access to the photovoltaic components when the photovoltaic components are connected together. The one or more openings may function to create access to one or more conductors, one or more connector channels, or both. The one or more openings may assist in connecting two or more photovoltaic components. The one or more openings may allow for a connector of a pv laminate to be removed and/or added to the photovoltaic array without moving or removing any photovoltaic components. The opening may function to allow an integrated frame, connector, or both to be removed from a concealed location, inserted into a concealed location, or both. The opening may allow for one or more tools to access an integrated frame, a connector, or both. The one or more openings may include one or more sockets so that a door may close the opening.

The one or more sockets may function to connect a door to the photovoltaic module. The one or more sockets may allow for rotational movement of the door between an open and closed position. The one or more sockets may lock a door in place. The one or more sockets may receive a portion of the door, a projection of the door, or both so that a connection is formed. The one or more sockets may be formed in one or more ribs. The one or more sockets may be located on an underside of the photovoltaic components. The one or more sockets may allow a door to be added and removed while the photovoltaic component is connected within the photovoltaic array.

The one or more doors may cover an opening. The one or more doors may function to prevent fluid from penetrating into an opening. The one or more doors may function to prevent fluid from moving in the opposite direction as the slope of the roof and penetrating the photovoltaic array. The one or more doors may seal an opening. The one or more doors may include a seal. The one or more doors may be free of a seal. The one or more doors may be locked in place when the photovoltaic array is complete. The one or more doors may be added after the photovoltaic array is created. The one or more doors may extend into the opening. The one or more doors may include one or more projections that connect the door within the photovoltaic device.

The one or more projections may function to connect a door within a socket, an opening, or both. The one or more projections may function to form a connection with a socket. The one or more projections may extend into a socket. The one or more projections may allow for a door to be removed from an opening a photovoltaic component, or both.

The photovoltaic array may be formed using a method. The method may include the steps of forming all or a portion of the photovoltaic array before any standard roofing components (e.g., shingles) are applied. The method may include a step of attaching the flashing components before any standard roofing components are applied. The method may include a step of adding standard roofing components and then adding photovoltaic components over a portion of the standard roofing components. Standard roofing components may be applied before and after the photovoltaic array is created but not at the same time as the photovoltaic array. The photovoltaic array, flashing components, or both may be placed over the standard roofing components. The standard roofing components may be inserted under the photovoltaic array, the flashing components, or both. A starter row may be formed. The starter row may be attached to a support structure (e.g., a roof) by one or more fasteners. The starter row may be one or more and preferably a plurality of photovoltaic components. The starter row may include center flashing pieces and corner flashing pieces. The starter row may begin and end with corner flashing pieces. The starter row may be overlapped by one or more active components. Forming one or more and preferably a plurality of internal rows over the starter row. Attaching the internal rows to the support structure. Attaching the internal rows to other internal rows. Attaching at least one internal row to a starter row. Overlapping an internal row with an ending row. Selecting a size of a photovoltaic. Installing a plus piece, a minus piece, a standard piece, or a combination thereof. Creating one or more symmetric edges of the photovoltaic component by selecting a piece that completes a row. Creating a stagger by selecting the size of the photovoltaic components. For example, a plus piece may by selected that overhangs a first photovoltaic component and covers a portions of a second photovoltaic component. Each active component may overlap two or more flashing components, two or more active components, or a combination of both. The connection members of one photovoltaic component may be aligned with another photovoltaic component. A connection hook may be blind inserted into a connection recess. The connection members may be locked together. The photovoltaic components may be moved vertically to create the lock (i.e., in a direction of the slope). The photovoltaic components may be aligned relative to each other. Cap extensions of one photovoltaic component may be aligned relative to a cap extension of another photovoltaic component. A cap extension of one photovoltaic component may be extended over a cap extension of an adjacent photovoltaic component and into a pocket of the cap extension. Pv laminates may be connected to active components. Pv laminates may be installed on the active components before installation, after installation, or a combination of both. Pv laminates may be connected to an active component, an active portion, a base plate, or a combination thereof. Connecting two or more rows together by inserting a row to row flashing piece at the end of two or more rows. Placing the row to row flashing piece over a portion of a row and forming a connection. Connecting the row to row flashing piece to a support structure. Placing a portion of a row over a row to row flashing piece. Connecting the row to the row to row flashing piece. Electrically connecting the rows together by connecting each of the rows to the row to row flashing piece. Electrically connecting the active components, the flashing components, or a combination thereof together so that a photovoltaic array is created. Forming an ending row. Covering one or more photovoltaic components with components of an ending row. Inserting connection hooks of the ending row into connection recesses of the last row before the ending row. Connecting the ending row to the support structure. Capping the photovoltaic array with an ending row so that the photovoltaic array is substantially water resistant (i.e., water does not extend through the photovoltaic array to the support structure). Creating a through roof connection by extending one or more wires through a support structure.

The method may include steps of replacing one or more photovoltaic laminates. The method of replacing a photovoltaic laminate may include removing one or more doors from one or more openings. Removing one or more connectors, integrated frames, or both through the one or more openings. Inserting one or more new connectors, new integrated frames, or both that are attached to a new pv laminate through the opening. Sealing the opening by reinstalling the door. Connecting the one or more connectors of the new pv laminate to one or more adjacent photovoltaic components (e.g., a photovoltaic module).

FIG. 1 illustrates a perspective view of a photovoltaic array 2 including a plurality of photovoltaic components 3. The photovoltaic array 2 includes three rows 4 of active components 20 with flashing components 60 located around the active components 20. As illustrated, the active components 20 are photovoltaic modules 21. The photovoltaic array 2 includes a peripheral edge 6 that forms an outer edge of the photovoltaic array 2. The photovoltaic array 2 includes a starter row 17 and an ending row 19 with a plurality of internal rows 18 extending therebetween. The starter row 17 is the first row formed and then the remaining rows are built off of the starter row 17.

FIG. 2 illustrates a cross sectional view of the photovoltaic array 2 of FIG. 1. The photovoltaic array 2 has a plurality of connecting members 10 that connect the active components 20 and the flashing components 60 together, the active components 20 to other active components 20, flashing components 60 to other flashing components 60, and a combination thereof. The connecting members 10 are located inside of a peripheral edge 6 of both the photovoltaic array 2 and each of the active components 20 and the flashing components 60. The connecting members 10 include both connection hooks 12 and connection recesses 14. The connection recesses 14 include a wall 16 that extends around each of the connection recesses 14. The active component 20 as shown includes an active portion 22 and an overlap portion 24. The active component 20 also includes a base plate 26 and a photovoltaic laminate 28 that generates power. The middle active component 20 is illustrated with the photovoltaic laminate 28 removed from the base plate 26.

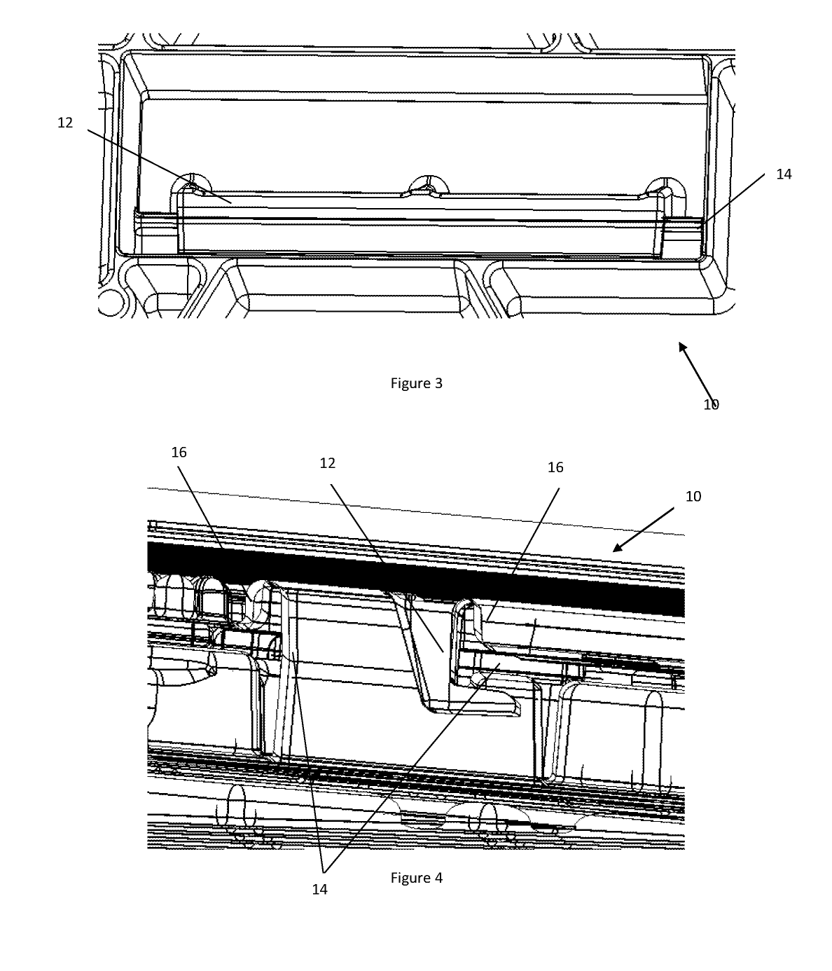

FIG. 3 illustrates a close-up view of a connection member 10 with the connection hook 12 extending through the connection recess 14 and hooking around to form a connection with the connection recess 14. The connection hook 12 contacts the connection recess 14 to prevent removal of an upper component from a lower component and to prevent wind uplift. The connection hook 12 and the connection recess 14 are both located inside of a peripheral edge of the photovoltaic components.

FIG. 4 illustrates a close-up view of the cross-sectional view of FIG. 2. As shown the connection members 10 are mated. The connection hook 12 is extended through the connection recess 14 and is in contact with the connection recess 14. A wall 16 extends around the connection recess 14 and the connection hook 12 that prevents fluids from penetrating to the next level of the photovoltaic array. The wall 16 of the connection recess 14 and the wall of the connection hook 12 form a complementary fit so that a tortuous path is created and fluid is prevented from penetrating through the connection recess 14.

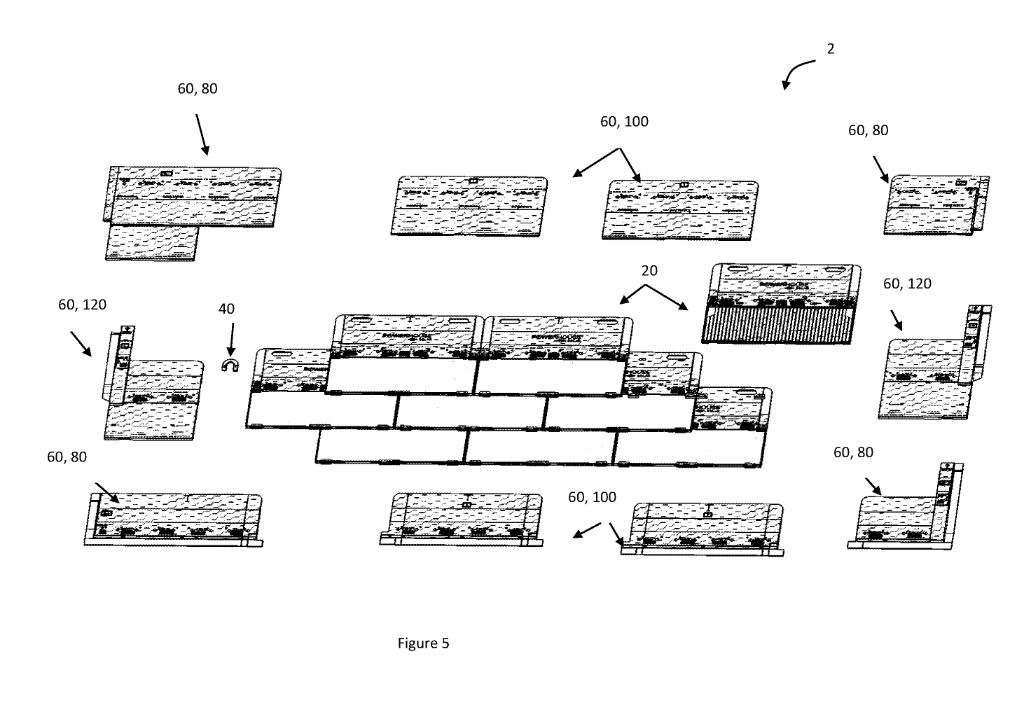

FIG. 5 illustrates an exploded view of the photovoltaic array 2. The photovoltaic array includes a plurality of active components 20 (e.g., photovoltaic modules) and a plurality of flashing components 60. The flashing components include corner flashing pieces 80, center flashing pieces 100, row to row flashing pieces 120, and a door 140 (not shown). One connector 40 is shown that interconnects (e.g., electrically and physically) the components together.

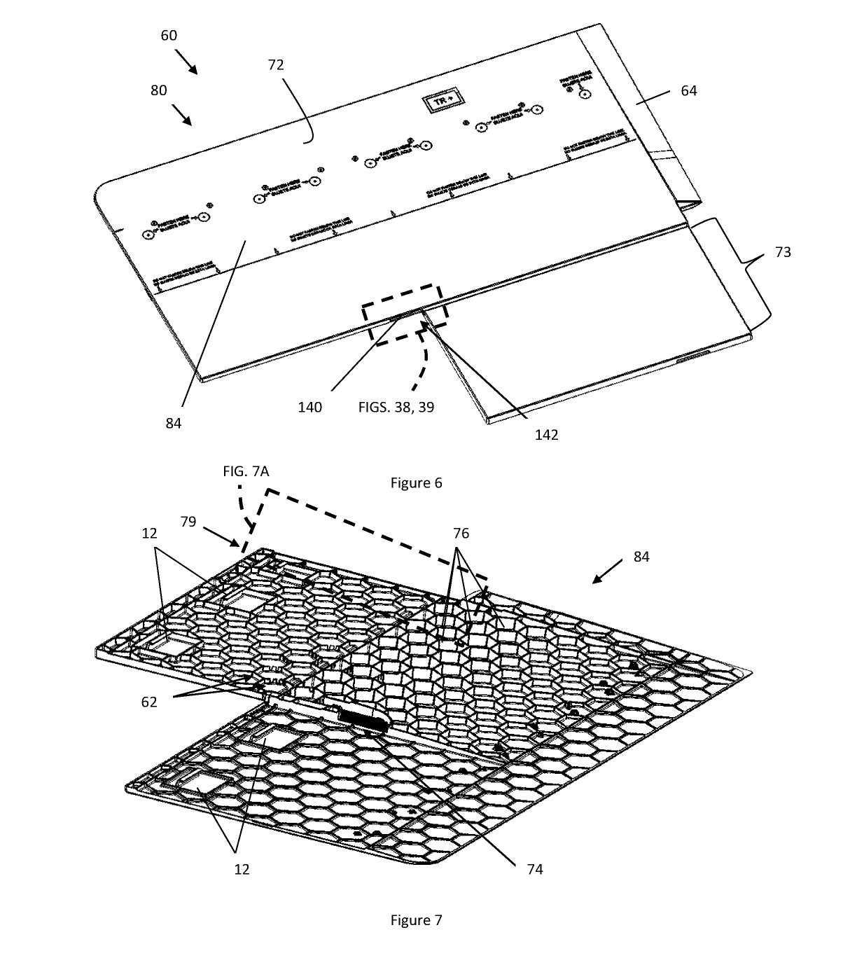

FIG. 6 illustrates a flashing component 60 that is a corner flashing piece 80. The corner flashing piece 80 is configured as a top right plus piece 84 that has a cap portion 72 that extends over an adjacent photovoltaic component (not shown) and the cap portion 72 has a side ledge 64 that moves fluid away from the photovoltaic array (shown in FIG. 1). The flashing component 60 includes a cap extension 73 that extends from the cap 72 over an adjacent flashing component (not shown) so that a shingle effect is created. The top right plus piece 84 includes a door 140 that covers an opening 142 so that fluid is prevented from extending under the top right plus piece 84.

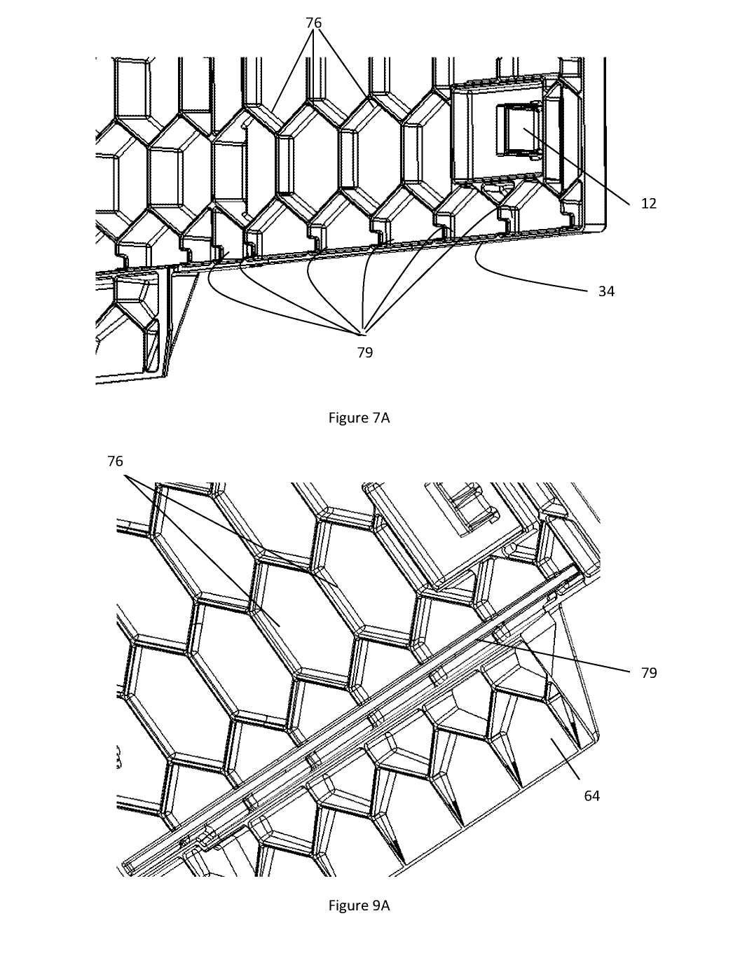

FIG. 7 illustrates a bottom perspective view of the top right plus piece 84 of FIG. 6. The top right plus piece 84 includes a plurality of snap slots 62 that extend through the ribs 76 and extend from the connector channel 74 so that the top right plus piece 84 can either connect to another photovoltaic component or extend through a roof. The snap slots 62 receive conductors that extend from the connector channels 74 and are connected to the active components (not shown) for allowing energy to extend therebetween. A plurality of connection hooks 12 extend from the bottom of the top right plus piece 84 so that the connecting hooks 12 can be inserted into a connection recess (not shown) in an adjacent photovoltaic component and a connection formed therebeween. An alignment slot 79 extends through some of the ribs 76 for receiving alignment ribs (not shown) and preventing movement of the top right plus piece 84 relative to an adjacent photovoltaic component.

FIG. 7A illustrates a close up view of the bottom of FIG. 7. An alignment slot 79 extends through the ribs 76. The alignment slot 79 extends between a side edge 34 and a connection hook 12.

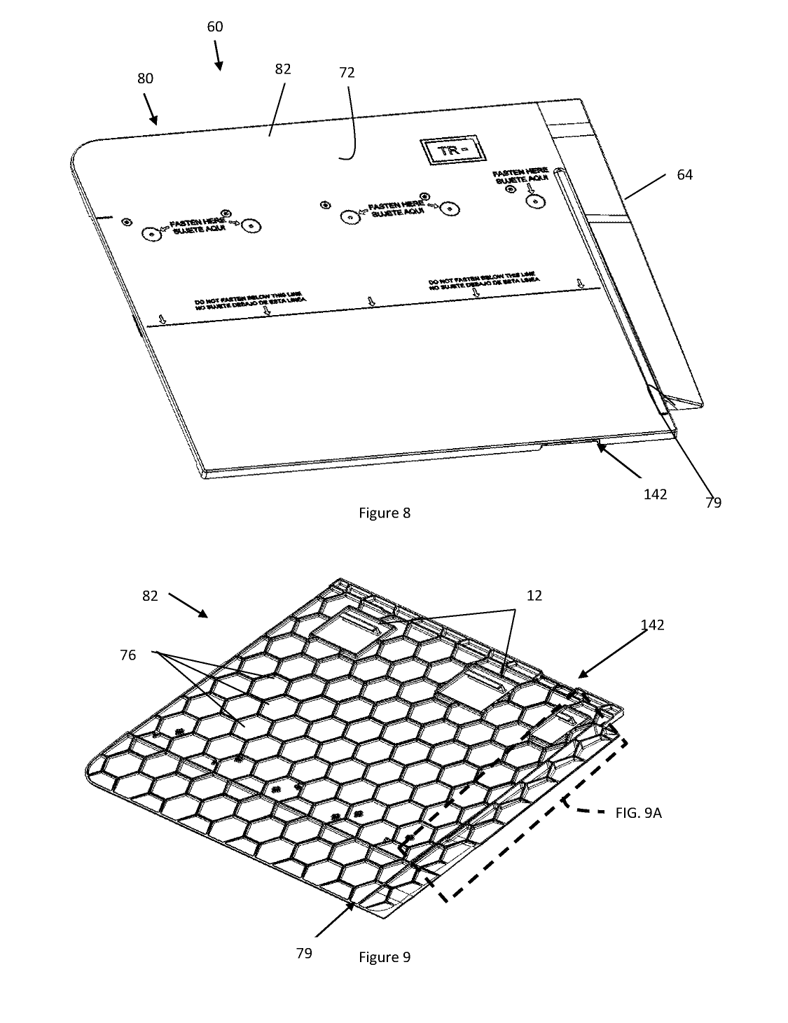

FIG. 8 illustrates a flashing component 60 that is a corner flashing piece 80. The corner flashing piece 80 is a top right minus piece 82. The top right minus piece 82 includes a cap portion 72 that extends over an adjacent photovoltaic component (not shown) and a side ledge 64 that guides fluids from the cap portion 72 off of the top right minus piece 82. An alignment slot 79 has a raised portion on a top surface of the top right minus piece 82 to assist in receiving an alignment rib (not shown). An opening 142 is shown on the bottom of the top right minus piece 82 and a door is not shown in the opening 142.

FIG. 9 illustrates a bottom perspective view of the top right minus piece 82 of FIG. 8. The bottom side includes a plurality of ribs 76 with a pair of connection hooks 12 that extend therefrom for forming a connection with a connection recess (not shown) of an adjacent photovoltaic component. The top right minus piece 82 also includes an opening 142 that as shown does not include a door.

FIG. 9A illustrates a bottom close-up view of an alignment slot 79 that extends through the plurality of ribs 76 on the bottom of the top right minus piece. The alignment slot 79 extends parallel to the side ledge 64.

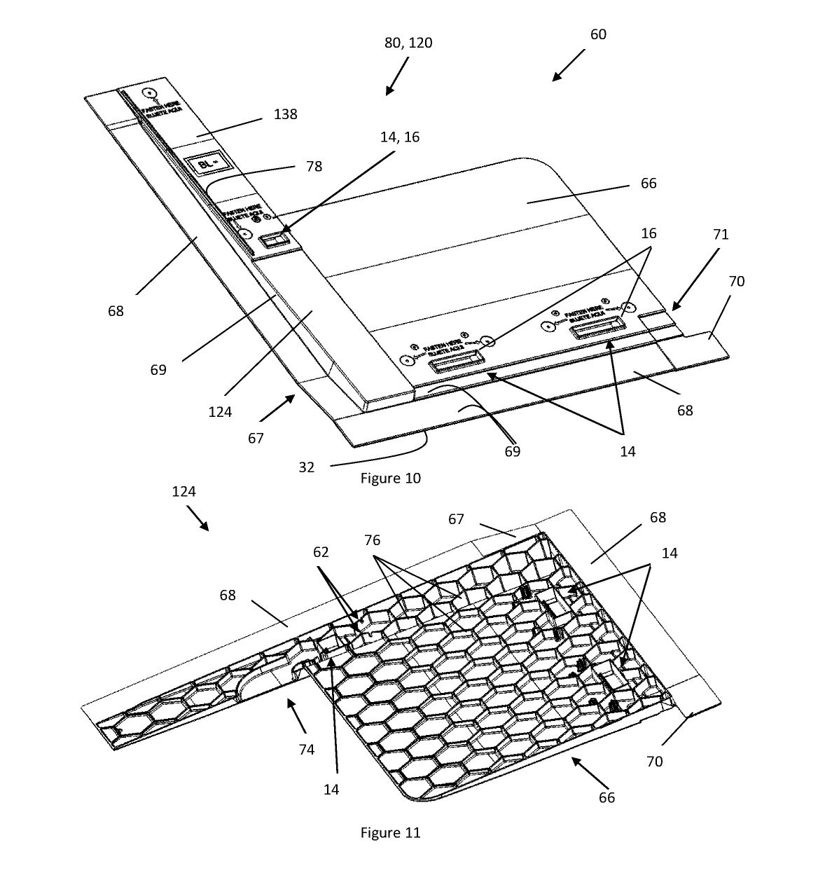

FIG. 10 illustrates a top perspective view of a flashing component 60 that serves as both a corner flashing piece 80 and as a row to row flashing piece 120. The flashing component 60 is a bottom left minus piece 124 and includes an overlap portion 66 and a row to row connector portion 138. The row to row connector portion 138 extends outward so that the row to row connector portion 138 connects the row to row flashing piece 120 to a photovoltaic component in its row as well as an adjacent row (shown in FIG. 1). The row to row connection portion 138 includes an alignment rib 78 that forms a connection with an alignment slot 79 (not shown), and a connection recess 14 including walls 16. The row to row connector portion 138 includes a flashing interface 68 that extends under another photovoltaic component or a roofing component to form a seal to resist penetration of fluids. The flashing interface 68 extends along two sides of the bottom left minus piece 124 so that a corner is created. The flashing interface 68 includes a ramp 67 along the side that changes the relationship of the flashing interface 68 from extending over standard shingles (not shown) along the bottom to extending under standard shingles (not shown) along the edge. A flashing wall 69 is adjacent to the flashing interface 68 and the flashing wall 69 creates a barrier and prevents fluid from extending from the flashing interface 68 onto the photovoltaic array (not shown). Two flashing walls 69 are located proximate to the bottom edge 32 so that a double tortuous path is created. The row to row connector portion 138 is connected to an overlap portion 66 that extends therefrom. The overlap portion 66 includes a pair of connection recesses 14 for receiving a connection hook (not shown) of an adjacent photovoltaic component. Each of the connection recesses 14 include a wall 16 that extends around the periphery of the connection recess 14 and prevents fluid from extending into the connection recess 14. A flashing extension 70 extends from the overlap portion 66 that extends under an adjacent photovoltaic component (not shown) so that water is prevented from penetrating between the bottom left minus piece 124 and the adjacent photovoltaic component. A pocket 71 is located adjacent to the flashing extension 70 and the pocket 71 receives a flashing extension 70 from an adjacent photovoltaic component to assist in preventing fluid penetration.

FIG. 11 illustrates a bottom perspective view of the bottom left minus piece 124 of FIG. 10. The bottom left minus piece 124 includes a connector channel 74 for receiving a portion of a connector (not shown). The connector connects conductors that extend through snap slots 62 in the ribs 76 so that the conductors can connect two adjacent photovoltaic components or form a through roof connection. Three connection recesses 14 extend through the bottom left minus piece 124 and form a through hole that receives a connection hook (not shown). A flashing interface 68 extends along two sides of the bottom left minus piece 124 and includes a flashing extension 70 that extends beyond an outer edge of the overlap portion 66. The flashing interface 68 includes a ramp 67 that changes the flashing interface 68 from extending over shingles to extending under shingles.

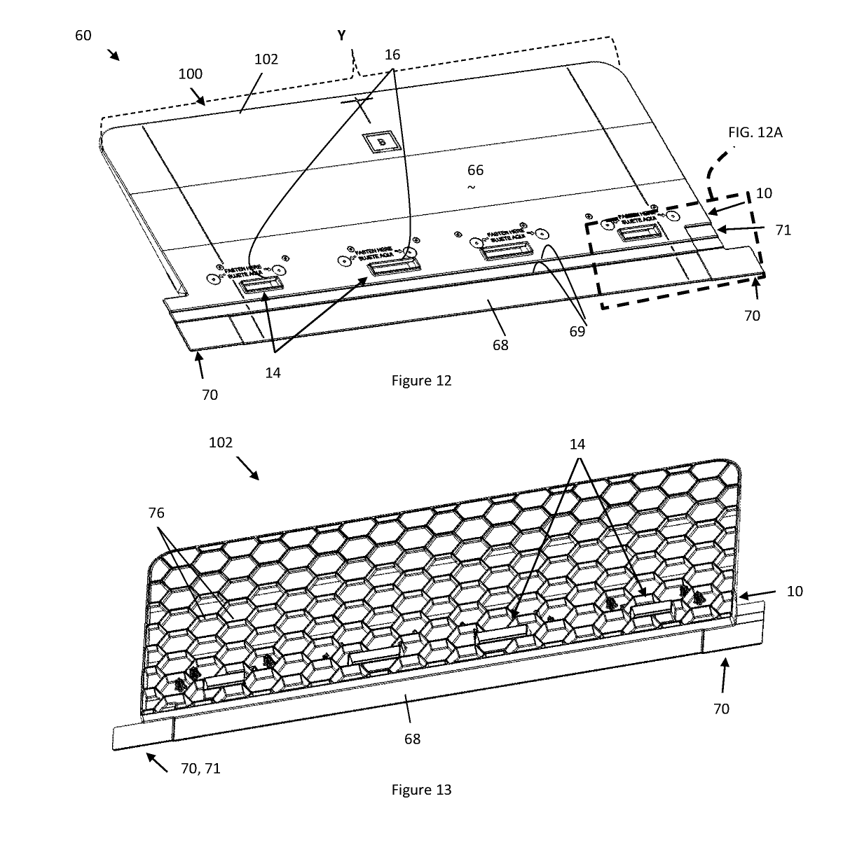

FIG. 12 illustrates a top perspective view of a flashing component 60 that is a center flashing piece 100. The center flashing piece 100 is a bottom piece 102 and has a width (Y) that is a standard width. The bottom piece 102 includes a flashing interface 68 that extends over an adjacent photovoltaic component or a shingle. The flashing interface 68 has a double flashing wall 69 that prevents fluid from going unto the photovoltaic array. Each end of the flashing interface 68 has a flashing extension 70. One of the flashing extensions 70 (e.g., a male flashing extension) is configured to extend over a flashing extension 70 with a pocket 71 (e.g., female flashing extension) and the other flashing extension 70 includes a pocket 71 that extends under and receives a flashing extension 70. Adjacent to the flashing interface 68 is a row of connection members 10. As shown the plurality of connection members 10 are connection recesses 14. Each of the individual connection recesses 14 include a wall 16 that extends around the connection recess and prevents fluid from entering the connection recess 14. A central portion of the bottom piece 102 is an overlap portion 66 that receives one or more photovoltaic components (not shown).

FIG. 12A illustrates a close-up view of a flashing interface 68 with a flashing extension 70. The flashing interface 68 has two flashing walls 69 that prevent fluid from entering the photovoltaic array (not shown). The flashing extension 70 includes a pocket 71 that receives a flashing extension of an adjacent photovoltaic component (not shown).

FIG. 13 illustrates a bottom perspective view of a bottom piece 102. The bottom piece 102 includes a flashing interface 68 that extends along a bottom of the bottom piece 102. Each end of the flashing interface 68 include a flashing extension 70. One flashing extension 70 includes a pocket 71 and is a female flashing extension and the opposing end is a male flashing extension. A row of connection members 10 extend along the bottom and include a plurality of connection recesses 14 that extend through the bottom piece 102 for receiving a connection hook (not shown). The bottom of the bottom piece 102 also includes a plurality of ribs 76.

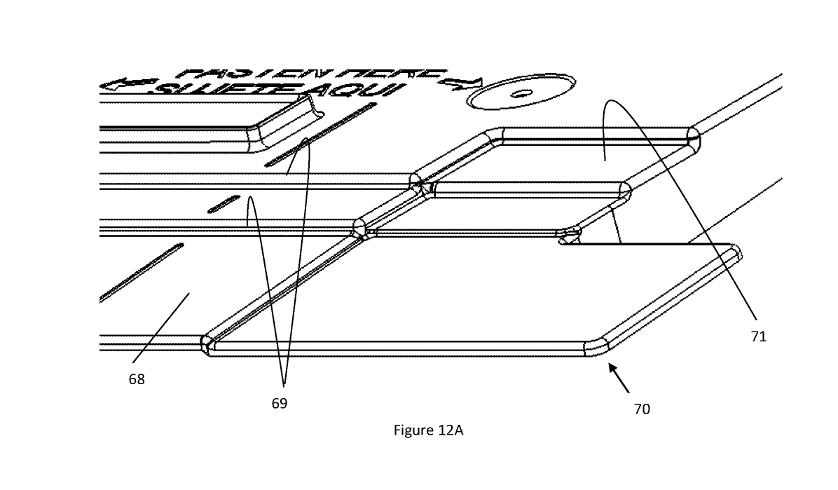

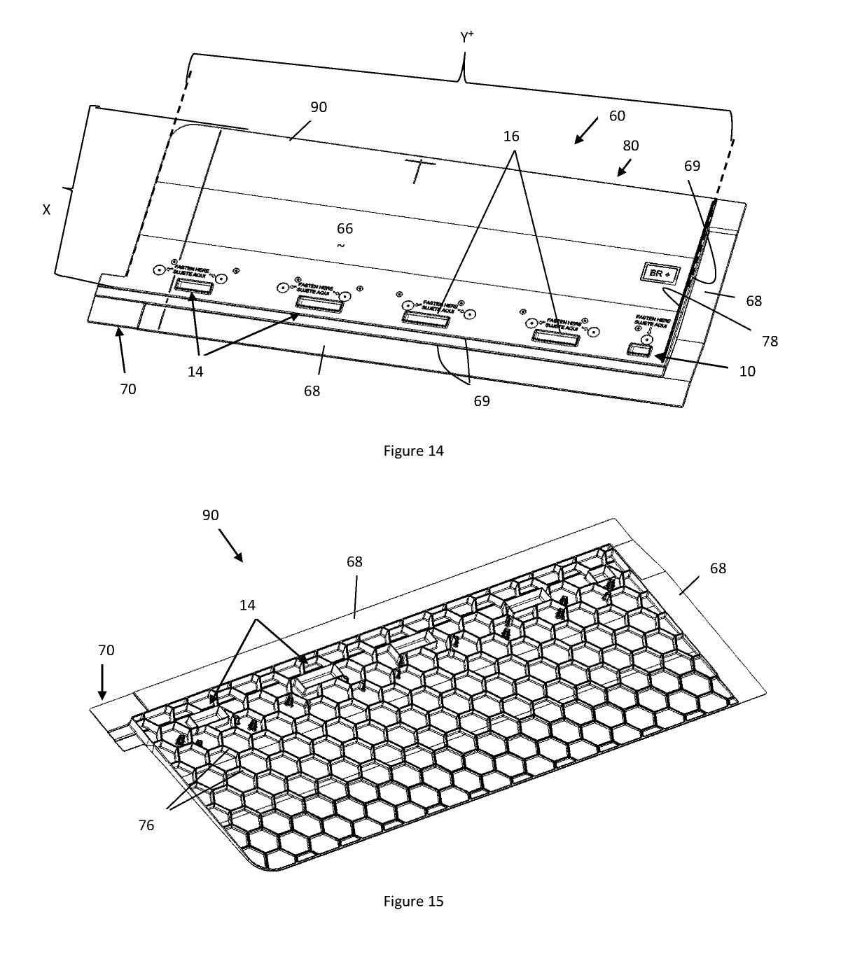

FIG. 14 illustrates a flashing component 60 that is a corner flashing piece 80 and is a bottom right plus piece 90. The bottom right plus piece 90 includes a flashing interface 68 that extends along two edges and includes a flashing wall 69 along both edges that prevent fluid from entering onto the photovoltaic array (not shown). An alignment rib 78 extends along a portion of the flashing walls 69 to further prevent fluid from entering the photovoltaic array (not shown) and for forming a connection with an adjacent photovoltaic component (not shown). The flashing interface 68 extends under shingles or one or more adjacent photovoltaic components along a vertical side edge and over shingles or one or more adjacent photovoltaic components along a bottom edge. The flashing interface 68 also includes a flashing extension 70 that extends laterally beyond the overlap portion 66. The overlap portion 66 receives a photovoltaic component and includes a row of connection members 10. The connection members 10 as shown are connection recesses 14 that include a wall 16 about each of the connection recesses 14 for preventing fluid penetration into the connection recesses 14. The bottom right plus piece 90 has a length (X) and a width (Y⁺) as shown.

FIG. 15 illustrates a bottom perspective view of a bottom right plus piece 90. The bottom right plus piece 90 includes a flashing interface 68 that extends along two edges and on one end includes a flashing extension 70. The bottom includes a plurality of ribs 76 and has connection recesses 14 that extends therethrough.

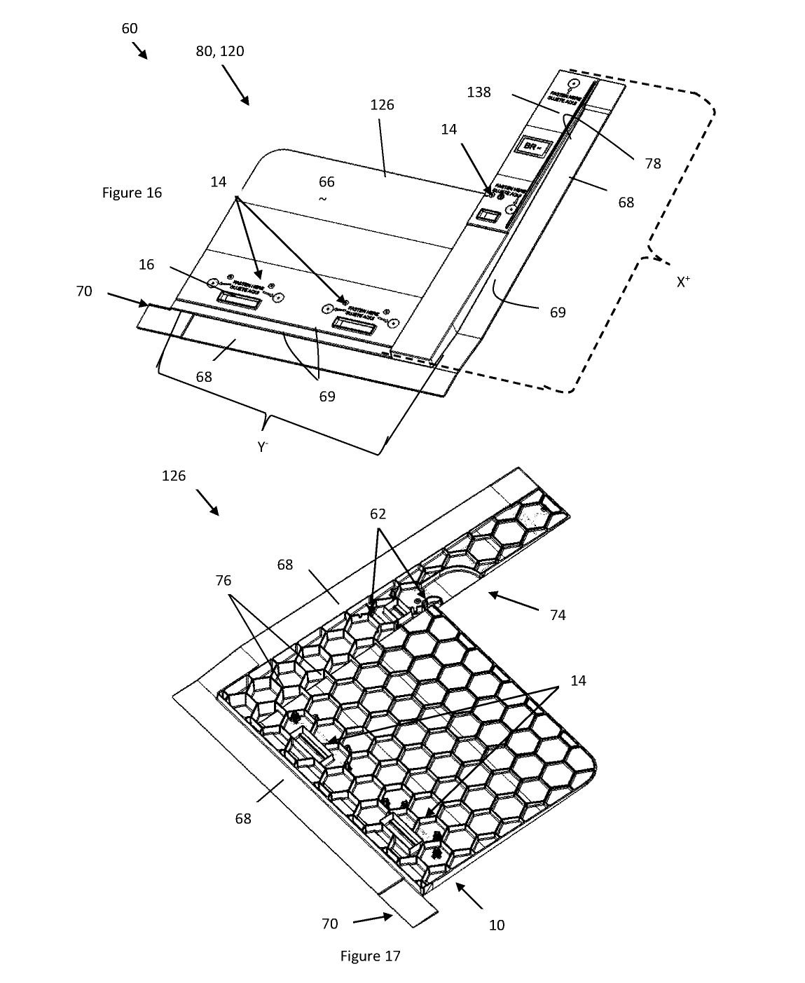

FIG. 16 illustrates a flashing component 60 that as shown is both a corner piece 80 and a row to row flashing piece 120. The flashing component 60 is a bottom right minus piece 126. The bottom right minus piece 126 includes a row to row connector portion 138 that extends between two adjacent rows and an overlap portion 66 extending from the row to row connector portion 138. The row to row connector portion 138 includes a flashing interface 68 and flashing walls 69 that prevent fluid from entering the photovoltaic array (not shown), and includes a connection recess 14. The flashing interface 68 and flashing walls 69 extend from the row to row connector portion 138 and partially around the overlap portion 66. An alignment rib 78 extends along a portion of the flashing walls 69 and assists in forming a connection with an adjacent photovoltaic component. An end of the flashing interface 68 includes a flashing extension 70. The overlap portion 66 receives a photovoltaic component and preferably a photovoltaic module (not shown) so that a connection member of the photovoltaic component forms a connection with the connection members 10 of the bottom right minus piece 126. The connection members 10 are connection recesses 14 that include walls 16 that extend around the connection recesses 14. The bottom right minus piece 126 has a width that is shorter than a standard width and is (Y⁻) and a height that is greater than a standard width and has a length (X⁺).

FIG. 17 illustrates a bottom perspective view of the bottom right minus piece 126 of FIG. 16. Two edges of the bottom right minus piece 126 include a flashing interface 68 with a flashing extension 70 on one end. A plurality of ribs 76 are located on the rear side, with a connector channel 74 and snap slots 62 being formed in the ribs for receiving a connector and conductors (not shown). A plurality of connection members 10 are formed in the ribs 76 with the connection members 10 being connection recesses 14.

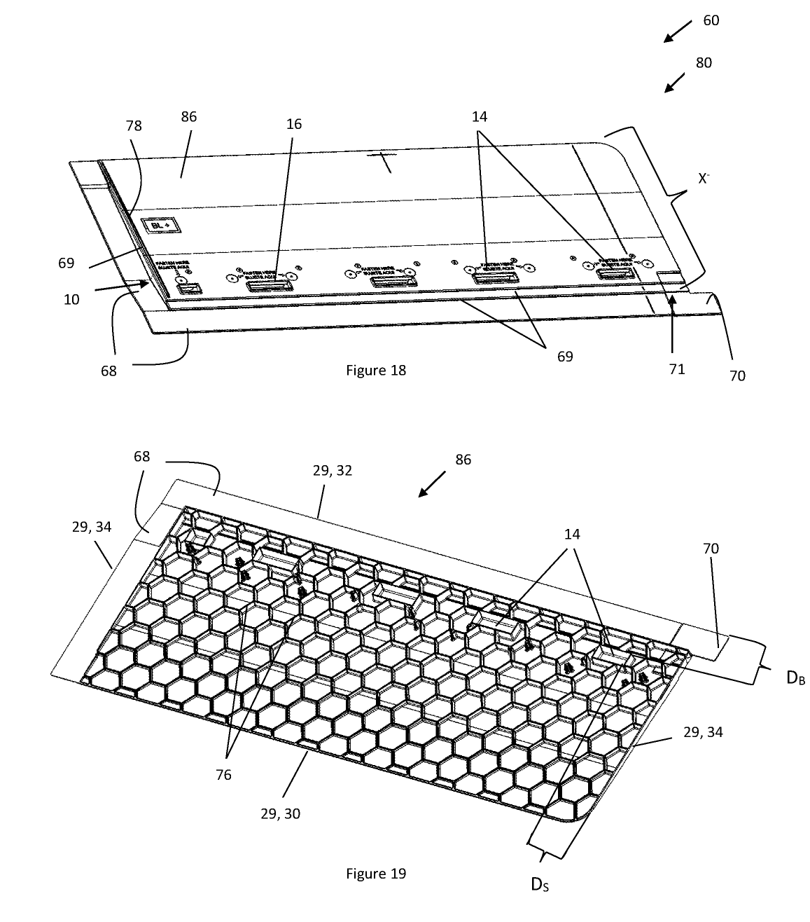

FIG. 18 illustrates a top perspective view of a flashing component 60 that is a corner flashing piece 80. The corner flashing piece 80 is a bottom left plus piece 86 and includes a row of connection members 10 that are configured as connection recesses 14 that extend through the bottom left plus piece 86, and each connection recess 14 includes a wall 16 that extends around each of the connection recesses 14. A flashing interface 68 extends along two edges of the corner flashing piece 80 so that the flashing interface 68 on a vertical edge can extend under a standard roofing material (e.g., roofing shingle) (not shown) and on a bottom edge extends over a standard roofing material. The bottom flashing interface 68 is located adjacent to two flashing walls 69 and the vertical edge flashing interface 68 is located adjacent to one flashing wall 69 to prevent fluid from moving from the roofing member (not shown) unto the bottom left plus piece 86. An alignment rib 78 extends along a portion of the flashing wall 69 so that the alignment rib 78 alignments with an alignment slot 79 (not shown) in an adjacent photovoltaic component (not shown). The flashing interface 68 includes a flashing extension 70 that includes a pocket 71 which extends under an adjacent photovoltaic component (not shown). The bottom left plus piece 86 has a length (X⁻) that is less than a standard piece such that a standard piece substantially covers the entire length of the bottom left plus piece 86 and has a portion that extends lengthwise into another row.

FIG. 19 illustrates a bottom view of the bottom left positive piece 86 of FIG. 18. The bottom includes a plurality of ribs 76 and connection recesses 14 that extend through the bottom left positive piece 86. The bottom left positive piece 86 has a peripheral edge 29 that includes a top edge 30 a bottom edge 32 and side edges 34 extending between and connecting the top edge 30 and the bottom edge 32. One side edge 34 and the bottom edge 32 include a flashing interface 68 and the flashing interface 68 on the bottom edge 32 includes a flashing extension 70. The connection recesses 14 are located a distance (D_{B}) from the bottom edge 32 and a distance (D_{S}) from the side edge 34 so that the connection recesses 14 are in an internal location.

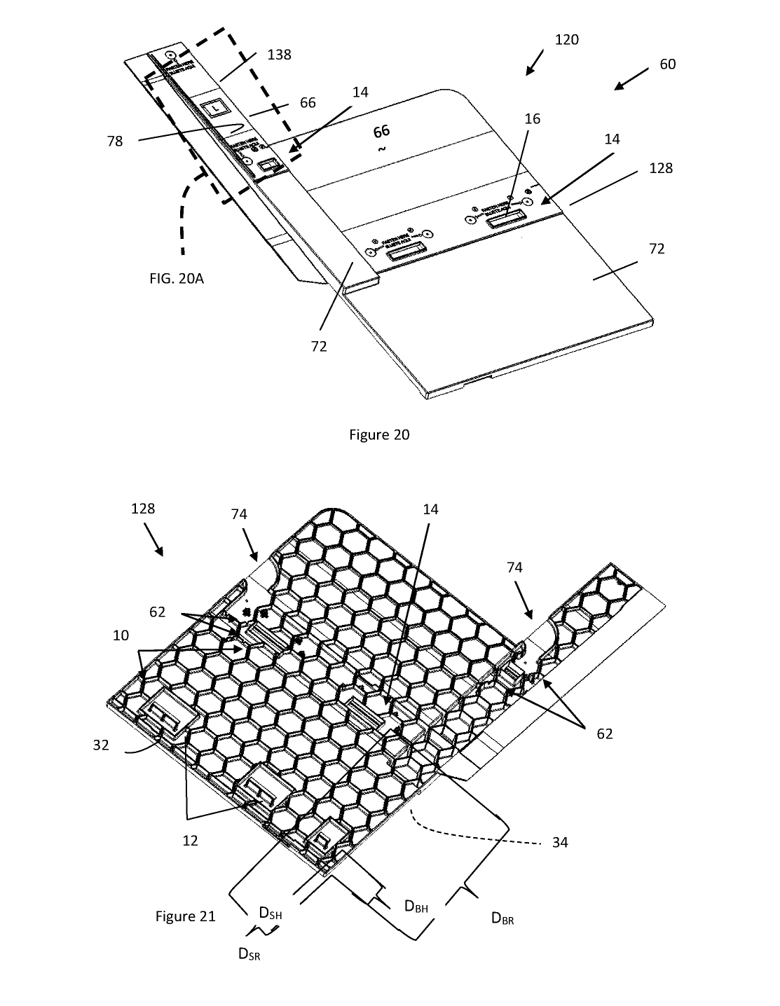

FIG. 20 illustrates a flashing piece 60 that is a row to row flashing piece 120. The row to row flashing piece 120 is a left piece 128. The left piece includes a row to row connector portion 138 that connects two adjacent rows together. The row to row connector portion 138 is connected to and includes both an overlap portion 66, a cap portion 72, and an alignment rib 78. The row to row connector portion 138 also includes a connection recess 14. The left piece connects two full rows together but extends between three rows. An overlap portion 66 of the row to row connector portion 138 extends under a first piece of a first row, the cap 72 of the row to row connection portion 138 and the overlap portion 66 are aligned in a second row, and the cap 72 connected to the overlap portion 66 extends over a piece in a third row. Connection recesses 14 extend through the left piece 128 for forming a connection with one or more adjacent components (not shown). Each of the connection recesses 14 are surrounded by a wall 16 that assists in preventing fluid from entering the connection recess 14.

FIG. 20A is a close-up view of the row to row connection portion 138 of FIG. 20. The row to row connection portion 138 includes a flashing interface 68 that is adjacent to a flashing wall 69 and an alignment rib 78 is located proximate to the top of the flashing wall 69, and includes a connection recess 14 having a wall 16. The alignment rib 78 assists in aligning two photovoltaic components together and preventing lateral movement of the photovoltaic components relative to each other.

FIG. 21 illustrates the bottom view of the left piece 128. As shown there are two spaced apart connector channels 74 for receiving a connector (not shown). Snap slots 62 extend from the connector channels 74 so that conductors can form electrical connections. A plurality of connection members 10 are shown with some of the connection members 10 being connection hooks 12 so that a portion of the left piece 128 can extend over and form a connection, and some of the connection members 10 being connection recesses 14 that an adjacent piece extends over and into to form a connection. The left piece 128 includes a side edge 34 and a bottom edge 32. The connection hook 12 is located in an internal portion of the left piece 128 so that the connection hook is located a distance (D_{SH}) from the side edge 34 and a distance (D_{BH}) from the bottom edge 32. The connection recess 14 is located in an internal portion of the left piece 128 so that the connection recess 14 is located a distance (D_{SR}) from the side edge 34 and a distance (D_{BR}) from the bottom edge 32. The connection recesses 14 and connection hooks 12 are also located a distance from the other edges although this is not shown.

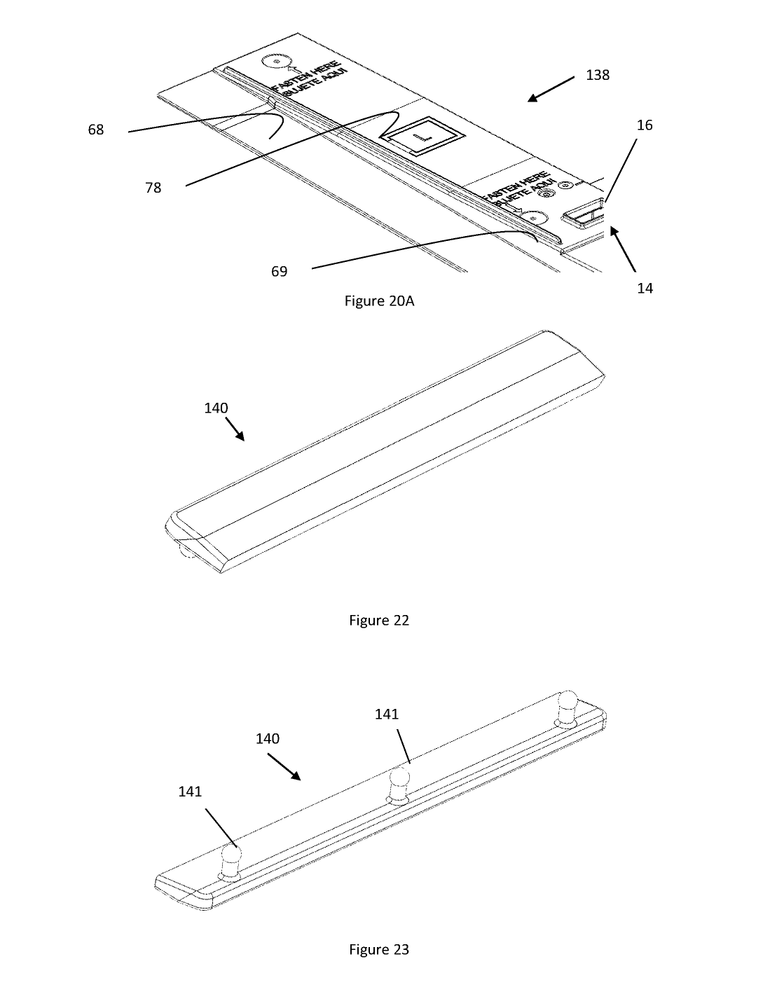

FIG. 22 illustrates a top perspective view of a door 140.

FIG. 23 illustrates a bottom perspective view of a door 140 including a plurality of spaced apart projections 141 that form a connection with a socket (not shown) of the opening (not shown).

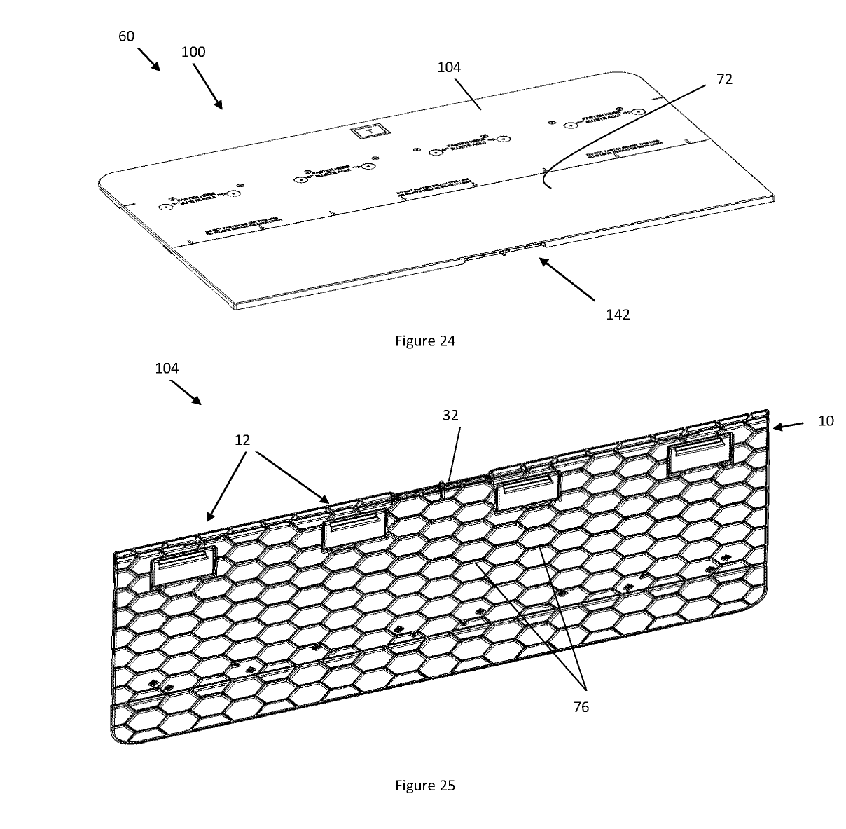

FIG. 24 illustrates a top perspective view of a flashing component 60 that is a center flashing piece 100 and is a top piece 104. The top piece 104 is a cap piece 72 that covers one or more adjacent photovoltaic components so that fluid flows down the photovoltaic array. The top piece 104 includes an opening 142 for exposing a portion of an adjacent photovoltaic component.

FIG. 25 illustrates a bottom perspective view of the top piece 104 of FIG. 24. The top piece 104 includes a row of connection members 10 that as shown are connection hooks 12. The connection hooks 12 are located internal of a bottom edge 32. The bottom of the top piece 104 includes a plurality of ribs 76.

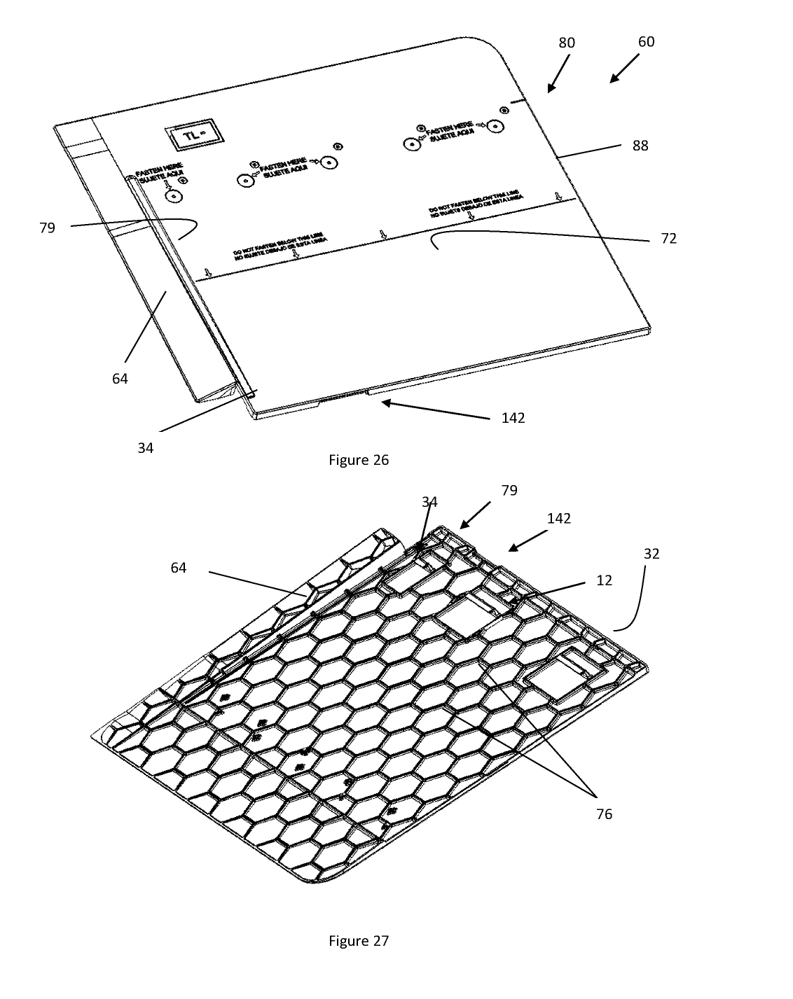

FIG. 26 illustrates a flashing component 60 that is a corner flashing piece 80. The corner flashing piece 80 is a top left minus piece 88 that is a cap portion 72 and extends over an adjacent photovoltaic component (not shown) forming a shingled section with no through holes for fluids to pass through. The top left minus piece 88 includes a side edge 34 with a side ledge 64 extending therefrom for forming an overlap with adjacent photovoltaic components or a shingle and for preventing fluid from extending onto the top left minus piece 88. A raised portion of an alignment slot 79 is located proximate to and extends along the side edge 34 and side ledge 64. A bottom edge 32 includes an opening 142.

FIG. 27 illustrates a bottom perspective view of the top left minus piece 88 of FIG. 26. The top left minus piece 88 includes a plurality of ribs 76 with a plurality of connection hooks 12 extending from the bottom side inside of the bottom edge 32. The bottom edge 32 includes an opening 142 for exposing an internal location of the top left minus piece 88 when a connection is formed. A side ledge 64 extends from the side edge 34 of the top left minus piece 88, and an alignment slot 79 extends along both the side edge 34 and the side ledge 64.

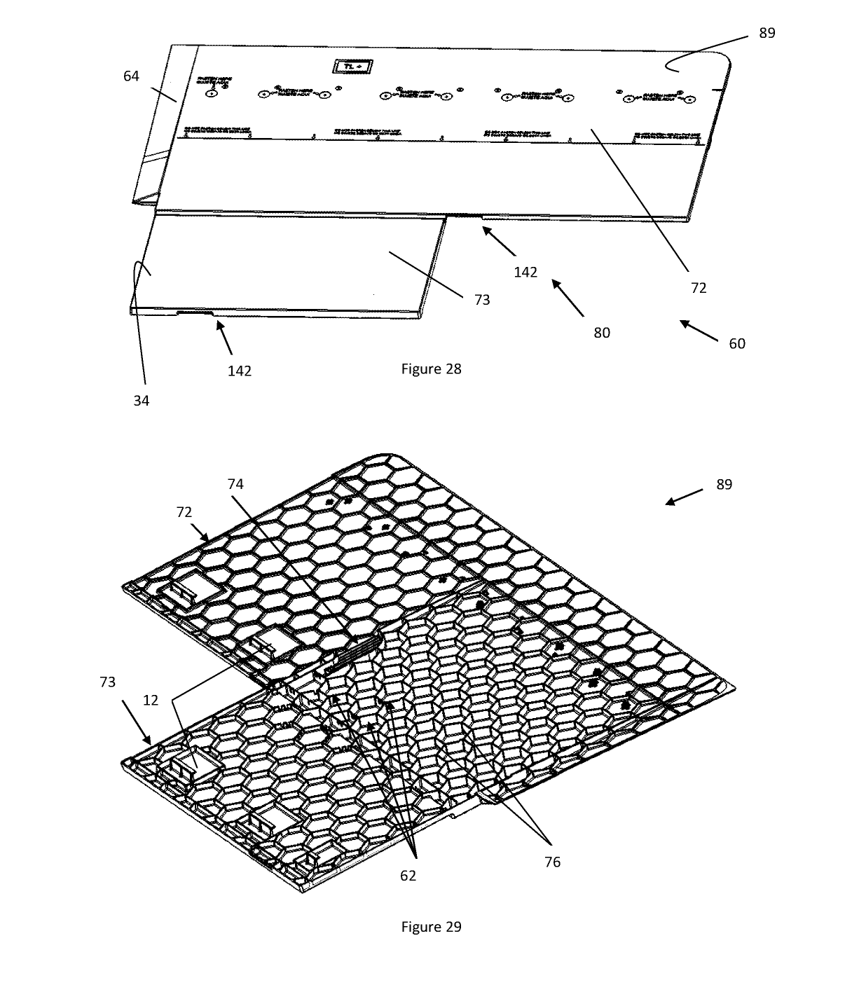

FIG. 28 illustrates a flashing component 60 that is a corner flashing piece 80. The corner flashing piece 80 is a top left plus piece 89. The top left plus piece 89 includes a cap portion 72 that extends over one or more photovoltaic components in a photovoltaic array (not shown). The cap portion 72 includes a side ledge 64 that forms a terminal edge. A cap extension 73 extends from the cap portion 72 an includes a side edge 34 that is free of a side ledge so that another component (not shown) that includes a side ledge can extend next to an under the cap extension 73. Both the cap extension 73 and the cap portion 72 include openings 142 for exposing a component (not shown) that is covered by the cap extension 73.

FIG. 29 illustrates a bottom perspective view of the top left plus piece 89 of FIG. 28. The top left plus piece 89 includes a plurality of ribs 76. Some of the plurality of ribs 76 include snap slots 62 that receive conductors for transferring power from the connector channel 74 to another location. Connection hooks 12 are located on both the cap portion 72 and the cap extension 73 and the connection hooks 12 are located on an internal location.

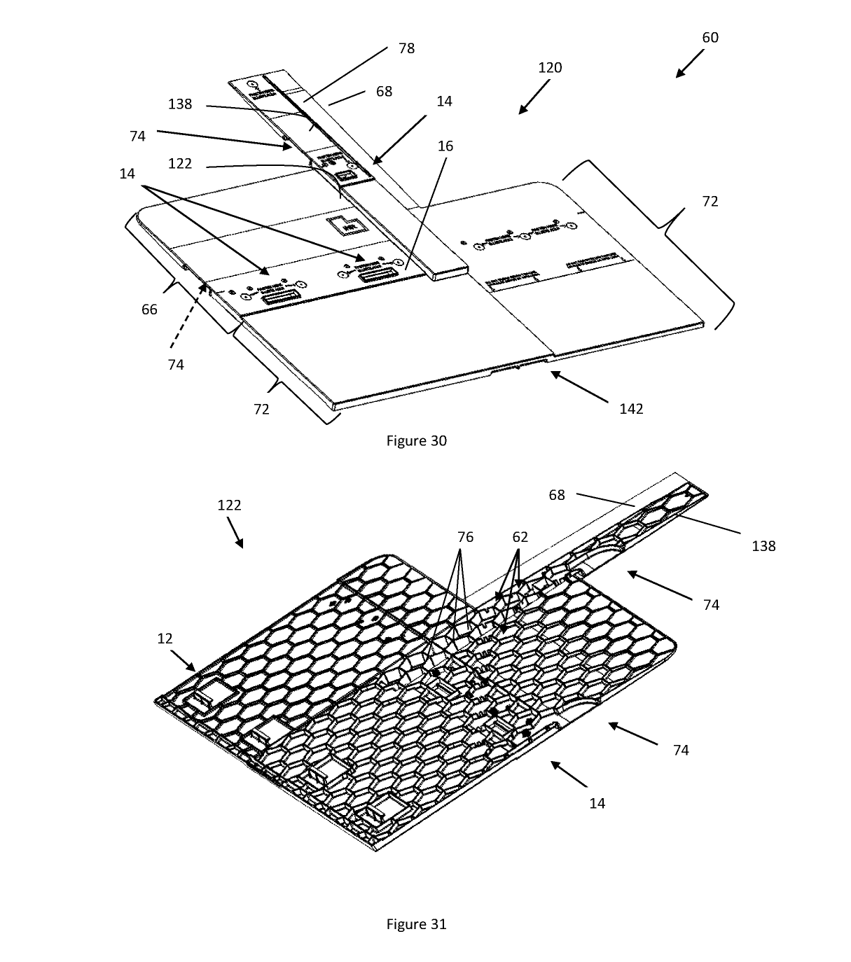

FIG. 30 illustrates a top perspective view of a flashing component 60 that is a row to row flashing piece 120. The row to row flashing piece 120 is a step in right piece 122. The step in right piece 122 includes two halves that are separated by a row to row connector portion 138 that includes a flashing interface 68 along one side and a connector channel 74 along an opposing side and an alignment rib 78 and connection recess 14 extending through a central portion. On a first side (e.g., right as shown) of the row to row connector portion 138 there is a cap portion 72 that extends over and covers one or more adjacent photovoltaic components so that fluid is prevents from extending through the photovoltaic components and a shingle effect is created. On the second side (e.g., left side as shown) of the row to row connector portion 138 there is partial cap portion 72 and overlap portion 66. The cap portion 72 includes an opening 142 that exposes an internal location of the step in right piece 122 and may be closed by a door (not shown). The overlap portion 66 includes connection recesses 14 that are each surrounded by walls 16. An edge of the overlap portion 66 includes an opening for a connector channel 74 so that an electrical connection can be formed.

FIG. 31 illustrates a bottom perspective view of the step in right piece 122 of FIG. 30. The step in right piece 122 includes a row to row connector portion 138 separating a first side and a second side. A flashing interface 68 is located on the first side of the row to row connector portion 138 and a connector channel 74 on the second side of the row to row connector portion 138. A plurality of ribs 76 extend within the row to row connector portion 138 and some of the ribs 76 include snap slots 62 extend from the connector channels 74 in the row to row connector portion 138 to the connector channel 74 in the second side. A plurality of connection hooks 12 extend from the first side to the second side. The second side includes connection recesses 14 that are located inside of the peripheral edge and spaced apart from the connection hooks 12.

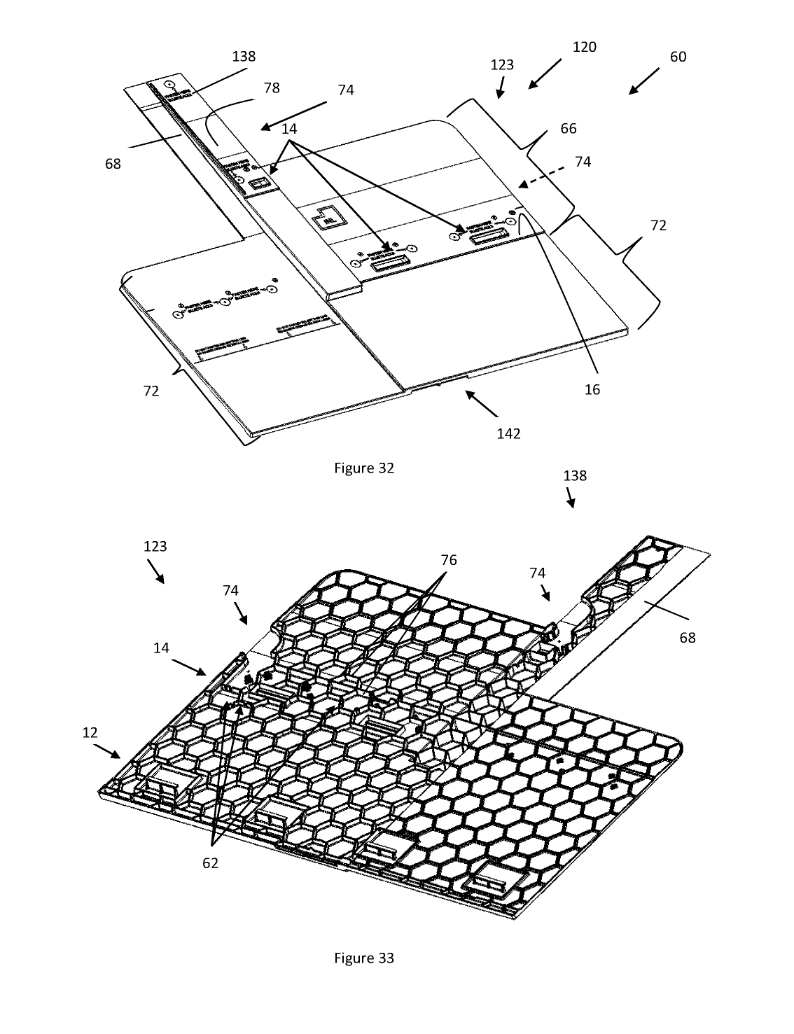

FIG. 32 illustrates a top perspective view of a flashing component 60 that is a row to row flashing piece 120. The row to row flashing piece 120 is a step in left piece 123. The step in left piece 123 includes two halves that are separated by a row to row connector portion 138 that includes a flashing interface 68 along one side and a connector channel 74 along an opposing side and an alignment rib 78 and connection recess 14 extending through a central portion. On a first side (e.g., left as shown) of the row to row connector portion 138 there is a cap portion 72 that extends over and covers one or more adjacent photovoltaic components so that fluid is prevents from extending through the photovoltaic components and a shingle effect is created. On the second side (e.g., right side as shown) of the row to row connector portion 138 there is partial cap portion 72 and overlap portion 66. The cap portion 72 includes an opening 142 that exposes an internal location of the step in right piece 122 and may be closed by a door (not shown). The overlap portion 66 includes connection recesses 14 that are each surrounded by walls 16. An edge of the overlap portion 66 includes an opening for a connector channel 74 so that an electrical connection can be formed. The step in left piece 123 is a mirror image of the step in right piece 122 of FIG. 30.

FIG. 33 illustrates a bottom perspective view of the step in left piece 123 of FIG. 32. The step in left piece 123 includes a row to row connector portion 138 separating a first side and a second side. A flashing interface 68 is located on the first side of the row to row connector portion 138 and a connector channel 74 on the second side of the row to row connector portion 138. A plurality of ribs 76 extend within the row to row connector portion 138 and some of the ribs 76 include snap slots 62 extend from the connector channels 74 in the row to row connector portion 138 to the connector channel 74 in the second side. A plurality of connection hooks 12 extend from the first side to the second side. The second side includes connection recesses 14 that are located inside of the peripheral edge and spaced apart from the connection hooks 12.

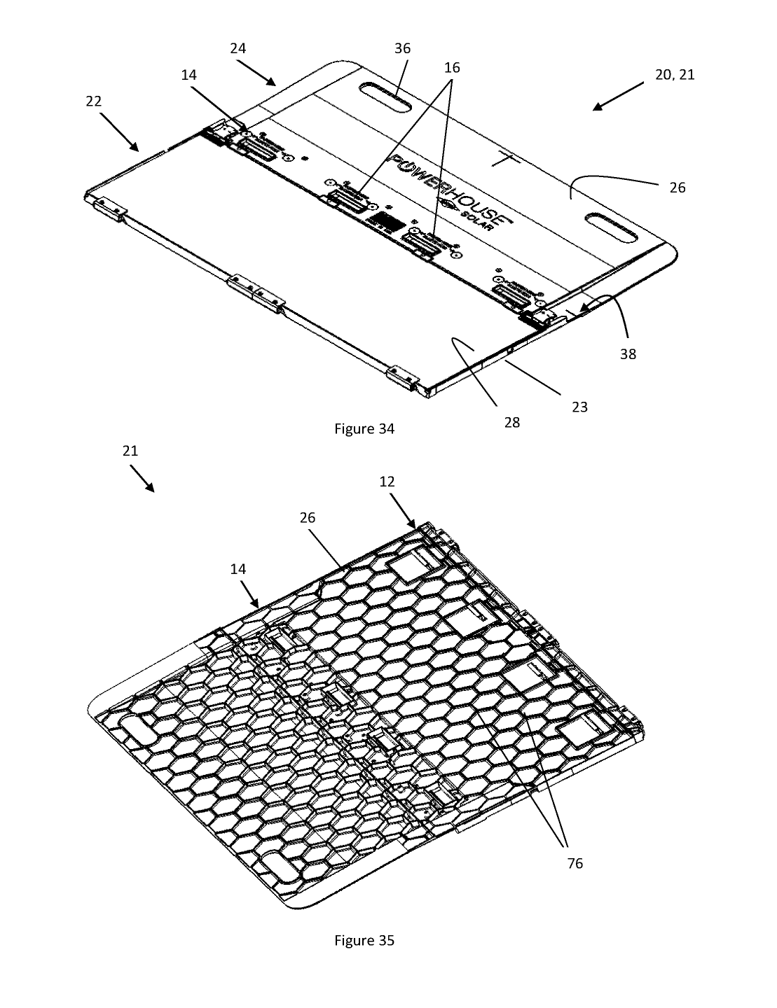

FIG. 34 illustrates a top perspective view of an active component 20 that is a photovoltaic module 21. The photovoltaic module 21 includes an active portion 22 and an overlap portion 24. The active portion 22 includes a photovoltaic laminate 28 that generates power and the overlap portion 24 includes connection recesses 14 for forming a connection with an adjacent photovoltaic component (not shown). The photovoltaic laminate 28 is located on a support portion 23 that provides support to the photovoltaic laminate 28. The active overlap portion 24 includes handles 36 for carrying the photovoltaic module 21 and connector channels 38 that assist in forming a connection with a connector (not shown). Each of the connection recesses 14 include a wall 16 that extends around a periphery of the connection recess 14. The photovoltaic laminate 28 sits on top of a base plate 26.

FIG. 35 illustrates a bottom perspective view of the base plate 26 of the photovoltaic module 21. The base plate 26 includes a plurality of ribs 76. The base plate also includes a plurality of connection hooks 12 and a plurality of connection recesses 14 that are located on an inside of the of the peripheral edge and are spaced apart from each other.

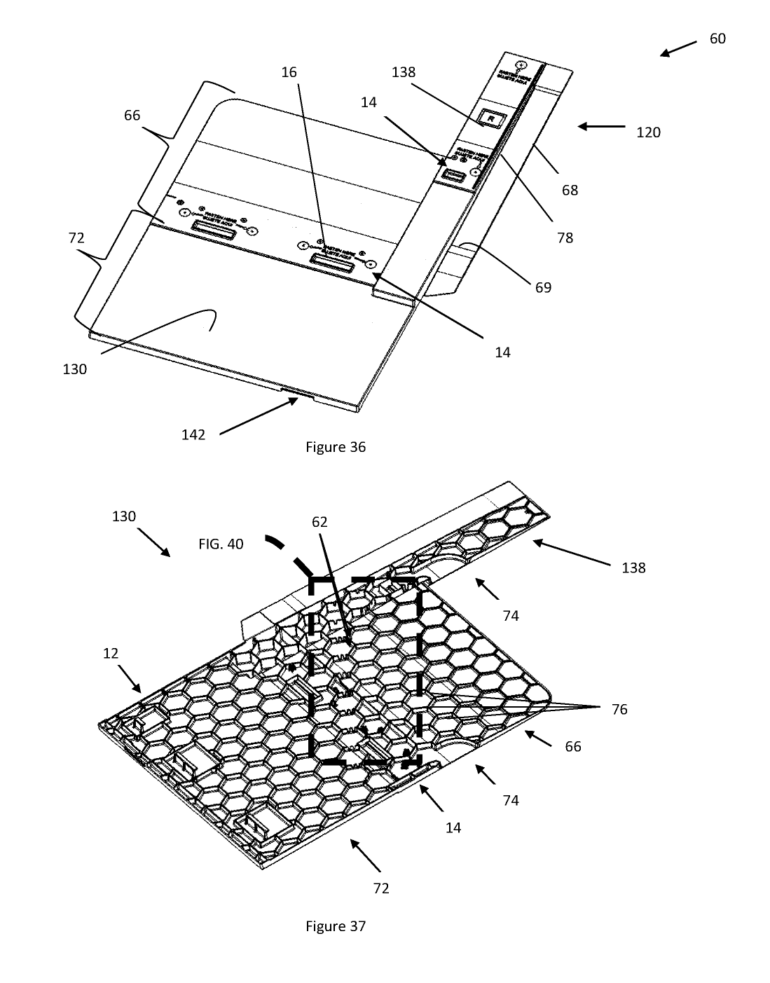

FIG. 36 illustrates a top perspective view of a flashing component 60 that is a row to row flashing piece 120. The row to row flashing piece 120 is a right piece 130. The right piece 130 includes a row to row connector portion 138 having a flashing interface 68 and a flashing wall 69 proximate to the flashing interface 68, and an alignment rib 78 extending along the row to row connector portion 138. The row to row connector portion 138 includes a connection recess 14. The row to row connector portion 138 is located between and connected to an overlap portion 66 and a cap portion 72. The overlap portion 66 includes connection recesses 14 that are surrounded by walls 16 so that fluid is prevented from flowing into the connection recesses 14. The cap portion 72 is located below the overlap portion 66 and the cap portion 66 includes an opening 142 along an edge.

FIG. 37 illustrates a bottom perspective view of the right piece 130 of FIG. 34. The right piece 130 includes a row to row connection portion 138 that includes ribs 76 and a connector channel 74. Some of the ribs 76 include snap slots 62 that extend from the connector channel 74 in the row to row connector portion 138 to the connector channel 74 in the overlap portion 66. Connection hooks 12 extend along an interior portion of the cap portion 72 and connection recesses 14 extend along an interior portion of the overlap portion 66.

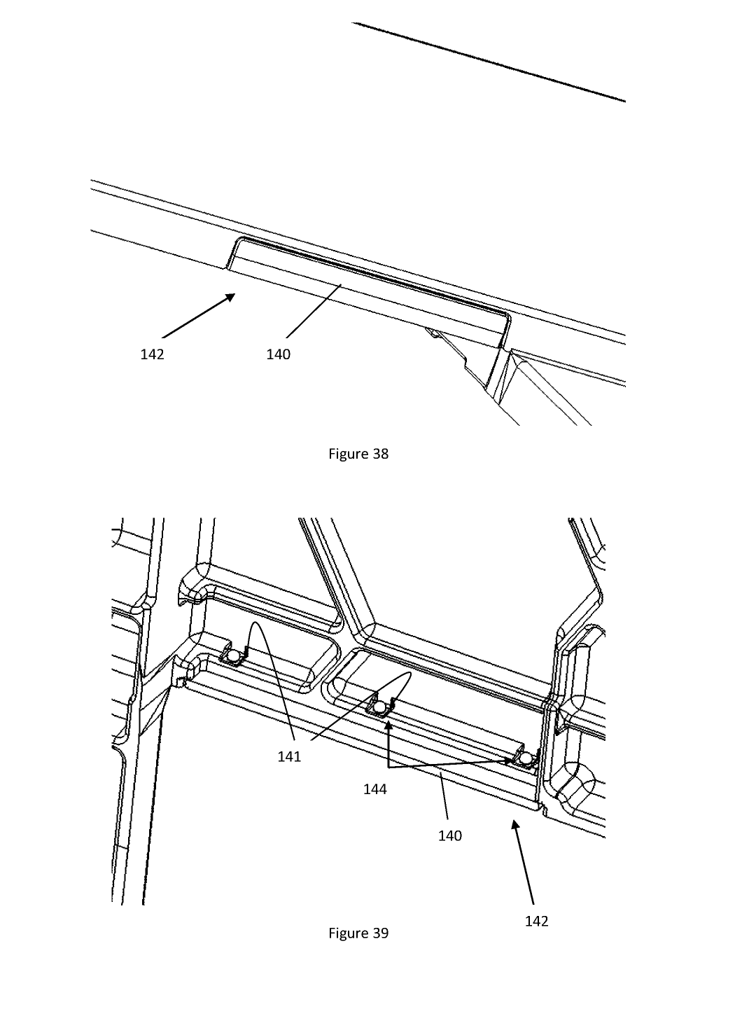

FIG. 38 illustrates a close-up view of the opening 142 including a door 140 of FIG. 6 so that a complete edge is formed.

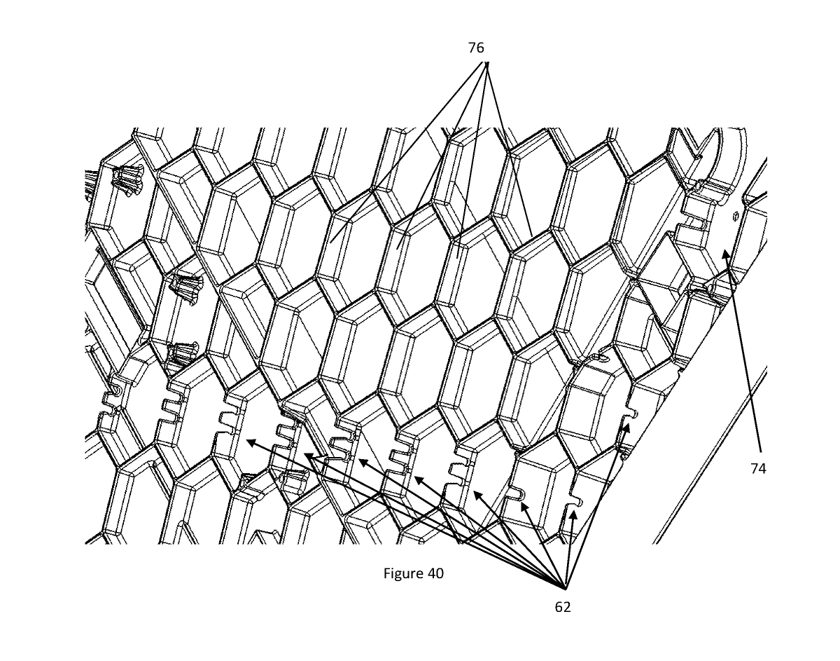

FIG. 39 illustrates a close-up view of the bottom of the opening 142 and door 140 of FIG. 36. The door 140 includes projections 141 that extend into the sockets 144 of the opening 142 so that a fixed connection is formed therebetween.

FIG. 40 illustrates a close-up view of the bottom of FIG. 37. The bottom includes a plurality of ribs 76. The ribs 76 have a plurality of snap slots 62 (e.g., single and double) that extend from a connector channel 74 so that conductors can connect to a connector (not shown) located within the connector channel 74.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A plurality of photovoltaic components comprising:
one or more rows of overlapping active components comprising a plurality of connection members; and
one or more flashing components comprising a plurality of connection members;
wherein the plurality of connection members of the one or more rows of overlapping active components and the plurality of connection members of the flashing components form a mating relationship in a mating region so that the one or more rows of overlapping active components and the one or more flashing components are connected together such that fluid is prevented from passing between the one or more rows of overlapping active components and the one or more flashing components in the mating region, and
wherein the connection members are located inward of a peripheral edge and/or prevent wind uplift.

2. The photovoltaic component of claim 1, wherein the one or more flashing components are a plurality of flashing components and two or more of the flashing components form a mating relationship in a mating region so that the two or more flashing components are connected together and prevent fluid from passing between the two or more flashing components in the mating region.

3. The photovoltaic component of claim 1, wherein the one or more overlapping rows of active components at least partially overlap the one or more flashing components or vice versa and the plurality of connection members of the active component and the plurality of connection members of the flashing component form a mating relationship in a mating region that is located inward of a peripheral edge so that the one or more active components and the one or more flashing components are connected together such that fluid is prevented from passing between the one more active components and the one or more flashing components in the mating region.

4. The photovoltaic component of claim 1, wherein one of the connection members is a connection hook and one of the connection members is a connection recess that receives the connection hook.

5. The photovoltaic component of claim 4, wherein the recess has walls to prevent fluid from entering in the recess.

6. The photovoltaic component of claim 5, wherein the connection hook has walls that extend around the connection hook and the walls form a complementary fit with the walls of the connection recess to prevent fluid from entering the recess.

7. The photovoltaic component of claim 1, wherein the one or more flashing components are a corner flashing piece.

8. The photovoltaic component of claim 1, wherein the one or more flashing components are a center flashing piece.

9. The photovoltaic component of claim 1, wherein the one or more flashing components are a row to row flashing piece.

10. The photovoltaic component of claim 1, wherein a top of at least one of the photovoltaic components include a cap that prevents fluid from passing through the plurality of photovoltaic components.

11. The photovoltaic components of claim 1, wherein at least one of the one or more flashing components include a side ledge.

12. The photovoltaic components of claim 11, wherein the side ledge forms a peripheral edge around the photovoltaic array.

13. The photovoltaic components of claim 1, wherein a bottom surface of the flashing components include a plurality of snap slots that receive conductors.

14. The photovoltaic components of claim 13, wherein the snap slots guide conductors between the one or more rows of overlapping active components and the one or more flashing components, between two or more active components of the one or more rows of overlapping active components, between two rows, or a combination thereof.

15. The photovoltaic components of claim 1, wherein the flashing components include an overlap portion.

16. The photovoltaic components of claim 1, wherein the one or more rows of overlapping active components include an active portion and an overlap portion.

17. The photovoltaic component of claim 16, wherein the overlap portion includes one or more connection hooks and one or more connection recesses.

18. A method of forming a photovoltaic array comprising:
forming a starter row by placing a plurality of photovoltaic components on a support structure;
attaching the starter row to the support structure;
placing one or more internal rows at least partially overlapping the starter row;
connecting the one or more internal rows to the starter rows; and
placing an ending row at least partially overlapping the internal rows so that a water resistant connection is formed between the ending rows and the starter rows.

19. The method of forming the photovoltaic array of claim 18, wherein the one or more internal rows are a plurality of internal rows and each of the plurality of internal rows are connected on at least one end to a row to row connector.

20. The method of forming the photovoltaic array of claim 18, wherein the starter row and the ending row are free of active components.

21. The method of forming the photovoltaic array of claim 18, wherein the method includes a step of removing one or more doors from one or more openings, removing one or more connectors of a photovoltaic laminate through the one or more openings, inserting one or more new connectors of a new photovoltaic laminate through the one or more openings, and closing the opening by reinstalling the door.
